(19) United States
(12) Patent Application Publication
(10) Pub. No.: US 2006/0165264 A1
(43) Pub. Date: Jul. 27, 2006

(54) Method and apparatus for acquiring images, and verification method and verification apparatus

(76) Inventors: Hirofumi Saitoh, Ogaki-city (JP); Tatsushi Ohyama, Ogaki-city (JP)

Correspondence Address: MCDERMOTT WILL & EMERY LLP, 600 13TH STREET, N.W., WASHINGTON, DC, 20005-3096, US

(21) Appl. No.: 11/339,480

(22) Filed: Jan. 26, 2006

(30) Foreign Application Priority Data
Jan. 26, 2005 (JP) 2005-018931
Jan. 26, 2005 (JP) 2005-018932
Jan. 26, 2005 (JP) 2005-018933
Nov. 30, 2005 (JP) 2005-346964

(51) Int. Cl. G06K 9/00

(52) U.S. Cl. 382/115

(57) ABSTRACT

In a verification apparatus, an image pickup unit picks up an image of an object to be verified. A calculation unit calculates, from the captured object image, a characteristic quantity that characterizes a direction of lines within the object image along a first direction or a characteristic quantity that characterizes the object image as a single physical quantity. Then a region from which data are to be acquired is set by referring to a characteristic quantity of the object image and, from this region, a characteristic quantity that characterizes a direction of lines within the object image along a second direction different from the second direction or a characteristic quantity that characterizes the object image as a single physical quantity is calculated. A verification unit at least verifies the characteristic quantity of the object image against that of a reference image along the second direction.

### BACKGROUND OF THE INVENTION

1. Field of the Invention

The present invention relates to method and apparatus for acquiring images using the biological information such as fingerprint and iris, and it relates also to verification method and verification apparatus used when carrying out the user authentication and the like.

2. Description of the Related Art

In recent years, the portable devices such as mobile-phones have been equipped with fingerprint authentication systems. Since the restrictions are then imposed on the memory or CPU performance of the portable devices unlike the desktop PCs and large-scale systems, the authentication method is required where the small number of memories and inexpensive CPU are implemented.

Conventional fingerprint identification methods are roughly classified into (a) minutiae method, (b) pattern matching method, (c) chip matching method and (d) frequency analysis method. In (a) minutiae method, minutiae, which are ridge endings, ridge bifurcations and other characteristic points of a fingerprint, are extracted from a fingerprint image, and information on these points are compared between two fingerprint images to verify the user's identity.

In (b) pattern matching method, image patterns are directly compared between two fingerprint images to verify the user's identity. In (c) chip matching method, a chip image, which is an image of a small area around minutiae, is enrolled as reference data, and verification of a fingerprint is done using this chip image. In (d) frequency analysis method, a frequency analysis is performed on a line slicing a fingerprint image, and a fingerprint is verified by comparing the frequency components perpendicular to the slice direction between two fingerprint images.

Reference (1) in the following Related Art List is a technology in which the characteristic vectors for fingerprint images or the like as well as the quality indicator therefor are extracted and then the reliability information obtained using the error distribution of the characteristic vectors are assigned to the characteristic quantities so as to carry out the verification of fingerprints using them.

Related Art List

(1) Japanese Patent Application Laid-Open No. Hei10-177650.

There are disadvantages for each of these methods. Both (a) minutiae method and (c) chip matching method involve a larger amount of calculation because of their necessity for such preprocessing as connecting severed points in picked-up images. (b) pattern matching method, which relies on the storage of entire image data, needs large memory capacity especially when data on a large number of persons are to be enrolled. And (d) frequency analysis method, which requires frequency conversion, tends to have a large amount of computation. The technology disclosed in the above Reference (1), which is based on a statistical analysis, also involves a large amount of computation.

### SUMMARY OF THE INVENTION

The present invention has been made in view of the foregoing circumstances and problems, and an object thereof is to provide a verification method and apparatus capable of carrying out highly accurate verification with a smaller memory capacity and a smaller amount of computation. Another object thereof is to provide an image acquiring method and apparatus capable of acquiring images with a smaller memory capacity and a smaller amount of calculation.

In order to solve the above problems, a verification method according to an embodiment of the present invention comprises: calculating, from a reference image for verification, a characteristic quantity that characterizes the direction of lines within the reference image along a first direction or a characteristic quantity that characterizes the reference image as a single physical quantity; setting a region from which data are to be acquired, by referring to the characteristic quantity; calculating, from the region from which data are to be acquired, a characteristic quantity that characterizes the direction of lines within the reference image along a second direction different from the first direction or calculating a characteristic quantity that characterizes the reference image as a single physical quantity; and recording the characteristic quantity along the second direction.

“Lines” may be ridge or furrow lines of a fingerprint. “A characteristic quantity that characterizes a direction of lines” may be a value calculated based on a gradient vector of each pixel. “A single physical quantity” may be a vector quantity or scalar quantity, and it may be a mode of image density switching, such as a count of switching of stripes. According to this embodiment, the reference data for verification can be enrolled using only a small memory capacity. When the characteristic quantities are to be calculated along a plurality of directions, the reference data with higher accuracy can be generated by using a calculation result obtained in a certain direction, instead of independently calculating the characteristic quantity for each of the plurality of directions.

The verification method may further comprise: calculating, from an object image for verification, a characteristic quantity that characterizes a direction of lines within the object image along the first direction or a characteristic quantity that characterizes the object image as a single physical quantity; setting a region from which data are to be acquired, by referring to the characteristic quantity; calculating, from the region from which data to be acquired, a characteristic quantity that characterizes a direction of lines within the object image along the second direction or a characteristic quantity that characterizes the object image as a single physical quantity; and verifying at least the characteristic quantity of the object image along the second direction against that of the reference image along the second direction.

The “verifying” may be such that the characteristic quantities, along the first direction, of the reference image and object image are verified against each other. According to this embodiment, the characteristic quantities are verified against each other, so that the verification can be performed with smaller memory capacity and smaller amount of calculation. The reference data generated with high accuracy as above and the object data generated similarly are verified against each other, so that the verification accuracy can be enhanced.

The reference image and the object image may be at least two pieces of picked-up images where an object could be present. An object may be a moving body. The “image” includes a thermal image, a distance image and the like. The “thermal image” is an image where each pixel value indicates thermal information. The “distance image” is an image where each pixel value indicates distance information. The verification method may further comprise recognizing a region where an object is located, based on a result verified in the verifying. In such a case, since the characteristic quantities of the two pieces of images are verified against each other, the position of an object can be recognized with less amount of calculation than a case when the pixel values themselves are compared and verified.

The recognizing may include: identifying a range in which an object is located in the first direction, based on a result of verifying the characteristic quantities of the reference image and object image along the first direction in the verifying; and identifying a range in which the object is located in the second direction, based on a result of verifying the characteristic quantities of the reference image and object image along the second direction in the verifying. In this case, the region where the object is located can be accurately recognized from the ranges of the object's position in the first direction and the second direction.

The verification method may further include: acquiring distance information in the region recognized by the recognizing; and identifying a distance of the object based on the acquired distance information. Alternatively, the reference image and the object image may each be a distance image where each pixel value indicates distance information, and the verification method may further include identifying a distance of the object, based on the distance information in the region recognized by the recognizing. In this case, the distance of an object can be identified, so that the applicability can be extended as the verification method. The verification method may further include identifying the posture of an object. In this case, the posture of an object can be identified, so that the applicability can be extended as the verification method.

The verification method may further comprise: coding data on the reference image and object image; and generating a stream that contains data coded by the coding and data on the region, recognized by the recognizing, where the object is located. In this case, the streams that contain data coded by the coding and data on the region, recognized by the recognizing, where the object is located are produced, so that the object in an image can be easily extracted from the generated streams when reproducing the generated streams.

Another embodiment of the present invention relates also to a verification method. This method comprises: dividing a reference image for verification, into a plurality of regions along a first direction; calculating, for each of the plurality of divided regions, a characteristic quantity that characterizes a direction of lines within each region or a characteristic quantity that characterizes each region as a single physical quantity and then generating a group of characteristic quantities along the first direction; setting a region from which data are to be acquired, by referring to the group of characteristic quantities; dividing the region from which data are to be acquired, into a plurality of regions along a second direction different from the first direction; and calculating, for each of the plurality of divided regions, a characteristic quantity that characterizes a direction of lines within the region or a characteristic quantity that characterizes the region as a single physical quantity, and generating a group of characteristic quantities along the second direction; and recording the group of characteristic quantities along the second direction.

A “group of characteristic quantities” may be functions of coordinate axes along the respective directions. The “setting” may be such that a region from which data are to be acquired is set by referring to a characteristic quantity to be marked out, such as a maximum value. According to this embodiment, the reference data for verification can be enrolled using only a small memory capacity. When the groups of characteristic quantities are to be calculated along a plurality of directions, the reference data with higher accuracy can be generated by using a calculation result obtained in a certain direction, instead of independently calculating the group of characteristic quantities for each of the plurality of directions.

The verification method may further comprise: dividing an object image for verification, into a plurality of regions along the first direction; calculating, for each of the plurality of divided regions, a characteristic quantity that characterizes a direction of lines within each region or a characteristic quantity that characterizes each region as a single physical quantity and then generating a group of characteristic quantities along the first direction; setting a region from which data are to be acquired, by referring to the group of characteristic quantities; dividing the region from which data are to be acquired, into a plurality of regions along the second direction; calculating, for each of the plurality of divided regions, a characteristic quantity that characterizes a direction of lines within the region or a characteristic quantity that characterizes the region as a single physical quantity, and generating a group of characteristic quantities along the second direction; and verifying at least the group of characteristic quantities of the object image along the second direction against that of the reference image along the second direction.

The “verifying” may be such that the group of characteristic quantities, along the first direction, of the reference image and object image are verified against each other. According to this embodiment, the groups of characteristic quantities are verified against each other, so that the verification can be performed with smaller memory capacity and smaller amount of calculation. The reference data generated with high accuracy as above and the object data generated similarly are verified against each other, so that the verification accuracy can be improved.

The verification method may further comprise: resetting a region from which data are to be acquired, by referring to the group of characteristic quantities along the second direction; dividing the region, from which data are to be acquired, into a plurality of regions along the first direction; calculating, for each of the plurality of divided regions, a characteristic quantity that characterizes a direction of lines within each region or a characteristic quantity that characterizes each region as a single physical quantity, and regenerating a group of characteristic quantities along the first direction.

According to this embodiment, part of the reference image or object image that contributes greatly to the verification can be stably extracted, so that highly accurate verification can be carried out.

Still another embodiment of the present invention relates also to a verification method. This method comprises: dividing a reference image or object image for verification into a plurality of regions; calculating, for each of the plurality of divided regions, a characteristic quantity that characterizes a direction of lines within each region or a characteristic quantity that characterizes each region as a single physical quantity and then generating a group of characteristic quantities along a predetermined direction; setting a region from which data are to be acquired, by referring to a characteristic quantity to be marked out among the group of characteristic quantities; dividing the region from which data are to be acquired, into a plurality of regions along the predetermined direction; and calculating, for each of the plurality of divided regions, a characteristic quantity that characterizes a direction of lines within each region or a characteristic quantity that characterizes each region as a single physical quantity and then regenerating a group of characteristic quantities along the predetermined direction.

According to this embodiment, part of the reference image or object image that contributes much to the verification can be stably extracted, so that highly accurate verification can be carried out.

Still another embodiment of the present invention relates also to a verification method. This method comprises: dividing a reference image or object image for verification into a plurality of regions; and calculating, for each of the plurality of divided regions, a characteristic quantity that characterizes a direction of lines within each region or a characteristic quantity that characterizes each region as a single physical quantity and then generating a group of characteristic quantities along a predetermined direction. The generating determines a range used for verification, by referring to a characteristic quantity to be marked out among the group of characteristic quantities.

According to this embodiment, part of the reference image or object image that contributes significantly to the verification can be stably extracted, so that highly accurate verification can be carried out.

Still another embodiment of the present invention relates to a verification apparatus. This apparatus comprises: an image pickup unit which takes an object image for verification; a calculation unit which calculates, from a picked-up object image, a characteristic quantity that characterizes a direction of lines within the object image along a first direction or a characteristic quantity that characterizes the object image as a single physical quantity; and a verification unit which verifies a characteristic quantity of the object image against a characteristic quantity of a reference image. The calculation unit sets a region from which data are to be acquired, by referring to the characteristic quantity of the object image and calculates, from the region from which data are to acquired, a characteristic quantity that characterizes a direction of lines within the object image along a second direction different from the first direction or a characteristic quantity that characterizes the object image as a single physical quantity, and the verification unit at least verifies the characteristic quantity of the object image along the second direction against that of the reference image along the second direction.

The “verification unit” may verify a characteristic quantity along the first direction of the object image against that along the first direction of the reference image. The verification apparatus may further comprise a recognition unit which recognizes a region where an object is located, based on a result verified in the verification unit. In such a case, since the characteristic quantities of the two pieces of images are verified against each other, the position of an object can be recognized with less amount of calculation than a case when the pixel values themselves are compared and verified. The recognition unit may include: a first identifying means which identifies a range in which an object is located in the first direction, based on a result of verifying the characteristic quantities of the reference image and object image along the first direction in the verification unit; and a second identifying means which identifies a range in which the object is located in the second direction, based on a result of verifying the characteristic quantities of the reference image and object image along the second direction in the verification unit. According to this embodiment, the characteristic quantities are verified against each other, so that the verification can be performed with smaller memory capacity and smaller amount of calculation. When the characteristic quantities are to be calculated for a plurality of directions, the accuracy of calculating the characteristic quantities in other directions can be enhanced by using a calculation result obtained in a certain direction. This in turn raises the verification accuracy.

Still another embodiment of the present invention relates also to a verification apparatus. This apparatus comprises: an image pickup unit which takes an object image for verification; a calculation unit which calculates, for each of a plurality of regions obtained as a result of dividing a picked-up object image along a first direction, a characteristic quantity that characterizes a direction of lines within each region or a characteristic quantity that characterizes the each region as a single physical quantity and then generating a group of characteristic quantities along the first direction; and a verification unit which verifies a group of characteristic quantities of the object image against that of a reference image. The calculation unit sets a region from which data are to be acquired, by referring to a group of characteristic quantities along the first direction and calculates, for each of a plurality of regions obtained as a result of dividing the region from which data are to be acquired along a second direction different from the first direction, a characteristic quantity that characterizes a direction of lines within the region or a characteristic quantity that characterizes the region as a single physical quantity and generates a group of characteristic quantities along the second direction, and the verification unit at least verifies the group of characteristic quantities of the object image along the second direction against that of the reference image along the second direction.

The “verification unit” may verify a group of characteristic quantities along the first direction of the object image against those along the first direction of the reference image. According to this embodiment, the group of characteristic quantities are verified against each other, so that the verification can be performed with smaller memory capacity and smaller amount of calculation. When the characteristic quantities are to be calculated for a plurality of directions, the accuracy of calculating the characteristic quantities in other directions can be enhanced by using a calculation result obtained in a certain direction. This in turn raises the verification accuracy.

In order to solve the above problems, a verification method according to an embodiment of the present invention comprises: calculating, from a reference image for verification, a characteristic quantity that characterizes a direction of lines within the reference image or a characteristic quantity that characterizes the reference image as a single physical quantity, in each of a plurality of directions; and recording a plurality of characteristic quantities calculated in the plurality of directions. “Lines” may be ridge or furrow lines of a fingerprint. “A characteristic quantity that characterizes a direction of lines” may be a value calculated based on a gradient vector of each pixel. “A single physical quantity” may be a vector quantity or scalar quantity, and it may be a mode of image density switching, such as a count of switching of stripes. According to this embodiment, the reference data of high accuracy can be enrolled using only a small memory capacity.

The verification method may further comprise: calculating, from an object image for verification, a characteristic quantity that characterizes a direction of lines within the object image or a characteristic quantity that characterizes the object image as a single physical quantity, in each of a plurality of directions; and verifying a plurality of characteristic quantities calculated along the plurality of directions of the object image against those calculated along the plurality of directions. According to this embodiment, a plurality of characteristic quantities are verified against one another, so that the verification can be performed using only a small memory capacity and with a small amount of calculation but with high accuracy.

The verifying may be performed whiles a correspondence between characteristic quantities to be verified is being varied. According to this embodiment, a rotation displacement of an object image from a reference image can be detected, thus improving the verification accuracy.

Another embodiment of the present invention relates also to a verification method. This method comprises: calculating, from a reference image for verification, a characteristic quantity that characterizes a direction of lines of the reference image or a characteristic quantity that characterizes the reference image as a single physical quantity, in at least one direction; calculating, from an object image for verification, a characteristic quantity that characterizes a direction of lines of the object image or a characteristic quantity that characterizes the object image as a single physical quantity, in at least one direction; and verifying the characteristic quantity for the object image against that for the reference image. The calculating from the reference image and the calculating from the object image are such that the characteristic quantity for either one of the reference image and the object image is calculated in one direction and that for the other is calculated in a plurality of directions, and the verifying is such that the characteristic quantity calculated in one direction and at least one or more of the characteristics quantities calculated in the plurality of directions are verified each other. According to this embodiment, the rotation error or rotation displacement can be detected by verifying the characteristic quantities in a one-to-many correspondence manner. Moreover, the verification can be performed using only a small memory capacity and with a small amount of calculation but with high accuracy.

Still another embodiment of the present invention relates also to a verification method. This method comprises: dividing a reference image for verification, into a plurality of regions in a plurality of directions; calculating, for each of the plurality of divided regions, a characteristic quantity that characterizes a direction of lines within each region or a characteristic quantity that characterizes each region as a single physical quantity, and generating a group of characteristics in each of the plurality of directions; and recording a plurality of groups of characteristic quantities calculated in the plurality of directions. In this embodiment, a “group of characteristic quantities” may be functions of coordinate axes along the respective directions. According to this embodiment, the reference data of high accuracy can be enrolled using only a small memory capacity.

This verification method may further comprise: dividing an object image for verification, into a plurality of regions in a plurality of directions; calculating, for each of the plurality of divided regions, a characteristic quantity that characterizes a direction of lines within each region or a characteristic quantity that characterizes each region as a single physical quantity, and generating a group of characteristics in each of the plurality of directions; recording a plurality of groups of characteristic quantities calculated in the plurality of directions; and verifying a group of characteristic quantities calculated in a plurality of directions of the object image against a group of characteristic quantities calculated in a plurality of directions of the reference image. According to this embodiment, the groups of characteristic quantities are verified against one another, so that the verification can be performed using only a small memory capacity and with a small amount of calculation but with high accuracy.

The verifying may be performed while a correspondence between the groups of characteristic quantities to be verified is varied. According to this embodiment, a rotation displacement of an object image from a reference image can be detected, thus improving the verification accuracy.

Still another embodiment of the present invention relates also to a verification method. This method comprises: dividing a reference image for verification, into a plurality of regions in at least one direction; calculating, for each of the plurality of divided regions, a characteristic quantity that characterizes a direction of lines within each region or a characteristic quantity that characterizes each region as a single physical quantity, and generating a group of characteristics in the at least one direction; dividing an object image for verification, into a plurality of regions in at least one direction; calculating, for each of the plurality of divided regions, a characteristic quantity that characterizes a direction of lines within each region or a characteristic quantity that characterizes each region as a single physical quantity and generating a group of characteristic quantities in the at least one direction; and verifying the group of characteristics of the object image against that of the reference image. The calculating from the reference image and the calculating from the object image are such that the characteristic quantity for either one of the reference image and the object image is calculated in one direction and that for the other is calculated in a plurality of directions, and the verifying is such that the group of characteristic quantities calculated in one direction and at least one or more of the groups of characteristics quantities calculated in the plurality of directions are verified each other. According to this embodiment, the rotation error or rotation displacement can be detected by verifying the group of characteristic quantities in a one-to-many correspondence manner. Moreover, the verification can be performed using only a small memory capacity and with a small amount of calculation but with high accuracy.

The calculating may be such that when groups of characteristic quantities are calculated in a plurality of directions, a reference image or object image is so rotated as to calculate the groups of characteristic quantities relative to a reference direction. The “reference direction” may be the vertical direction or horizontal direction. According to this embodiment, the group of characteristic quantities in a plurality of directions can be calculated by using a simple algorithm.

When the groups of characteristic quantities are calculated along an oblique direction, the calculating may be such that the region is set as a set of a plurality of sub-regions and a characteristic quantity is rotated for each of the plurality of sub-regions. A “sub-region” may be a square region along the reference direction. If the characteristic quantity within the “sub-region” is defined as a value calculated based on a gradient vector of each pixel, each gradient vector may be rotated in accordance with an angle of the oblique direction formed relative to the reference direction. If this gradient vector is rotated, it may be rotated by referring to a predetermined conversion table. The groups of characteristics in a plurality directions can be calculated with a small amount of calculation.

According to an assumed range of a relative position relationship between an object image to be picked up and an image pickup element, the calculating may determine a range of angles formed relative to a reference direction set when the groups of characteristic quantities are calculated in the plurality of directions. Since according to this embodiment there is no need of going through the trouble of calculating a group of characteristic quantities in a direction, which is most probably of no use, and recording and verifying them, the verification can be performed using only a small memory capacity and with a small amount of calculation but with high accuracy.

Still another embodiment of the present invention relates to a verification apparatus. This apparatus comprises: an image pickup unit which takes a reference image and an object image for verification; a calculation unit which calculates, from a picked-up reference image, a characteristic quantity that characterizes a direction of lines within the reference image or a characteristic quantity that characterizes the reference image as a single physical quantity, in a plurality of directions, and calculates, from a picked-up object image, a characteristic quantity that characterizes a direction of lines within the object image or a characteristic quantity that characterizes the object image as a single physical quantity, in a plurality of directions; and a verification unit which verifies a plurality of characteristic quantities calculated in the plurality of directions of the object image against a plurality of characteristic quantities in a plurality of directions of the reference image. According to this embodiment, pluralities of characteristic quantities are verified against one another, so that the verification can be performed using only a small memory capacity and with a small amount of calculation but with high accuracy.

The verification may carry out a verification while a correspondence between the groups of characteristic quantities to be verified is being varied. According to this embodiment, a rotation displacement of an object image from a reference image can be detected by varying the correspondence. Hence, the verification can be performed using only a small memory capacity and with a small amount of calculation but with high accuracy.

Still another embodiment of the present invention relates also to a verification apparatus. This apparatus comprises: an image pickup unit which takes a reference image and an object image for verification; a calculation unit which calculates, from a picked-up reference image, a characteristic quantity that characterizes a direction of lines within the reference image or a characteristic quantity that characterizes the reference image as a single physical quantity, in at least one direction, and calculates, from a picked-up object image, a characteristic quantity that characterizes a direction of lines within the object image or a characteristic quantity that characterizes the object image as a single physical quantity, in the at least one direction; and a verification unit which verifies a characteristic quantity of the object image against that of the reference image. The verification unit calculates the characteristic quantity for either one of the reference image and the object image in one direction and the characteristic quantity for the other in a plurality of directions, and the verification unit verifies the characteristic quantity calculated in one direction and at least one or more of the characteristics quantities calculated in the plurality of directions. According to this embodiment, the rotation error or rotation displacement can be detected by verifying the characteristic quantities in a one-to-many correspondence manner. Moreover, the verification can be executed using only a small memory capacity and with a small amount of calculation but with high accuracy.

According to an assumed range of a relative position relationship between an object image to be picked up and an image pickup element, the calculation unit may determine a range of angles formed relative to a reference direction set when the characteristic quantities are calculated in the plurality of directions. The “image pickup unit” may include a guide portion that regulates the movement of an object to be captured on an image pickup area. The image pickup unit may includes a line sensor. Since according to this embodiment there is no need of going through the trouble of calculating a characteristic quantity in a direction, which is most probably of no use, and recording and verifying it, the verification can be carried out using only a small memory capacity and small amount of calculation but with high accuracy.

In order to solve the above problems, an image acquiring method according to an embodiment of the present invention comprises: acquiring an object image as a plurality of partial images; calculating, for each of the plurality of partial images, a characteristic quantity that characterizes a direction of lines of each partial region or a characteristic quantity that characterizes each partial image as a single physical quantity; and constructing the object image into a single piece of entire image by use of the characteristic quantity for each partial image or constructing a characteristic quantity obtained when the object image is constructed into a single piece of entire image by use of the characteristic quantity for each partial image.

“Lines” may be ridge or furrow lines of a fingerprint. “A characteristic quantity that characterizes a direction of lines” may be a value calculated based on a gradient vector of each pixel. “A single physical quantity” may be a vector quantity or scalar quantity, and it may be a mode of image density switching, such as a count of switching of stripes. According to this embodiment, the images can be acquired using only a small memory capacity and with a small amount of calculation required.

Another embodiment of the present invention relates also to an image acquiring method. This method comprises: acquiring an object image as a plurality of partial images; dividing each of the plurality of partial images into a plurality of regions along a predetermined direction; calculating, for each of the plurality of divided regions, a characteristic quantity that characterizes a direction of lines within each region or a characteristic quantity that characterizes each region as a single physical quantity and generating, for each of the plurality of partial images, a group of characteristic quantities along the predetermined direction; and constructing the object image into a single piece of entire image by use of correspondence of the groups of characteristic quantities among the partial images or constructing a characteristic quantity obtained when the object image is constructed into a single piece of entire image by use of correspondence of the groups of characteristic quantities among the partial images.

A “group of characteristic quantities” may be functions of coordinate axes along the respective directions. According to this embodiment, the images can be acquired using only a small memory capacity and with a small amount of calculation required.

The constructing may be such that when parts of the object image overlap between the partial images, the partial images are joined together so that corresponding parts of the groups of characteristic quantities between the partial images are superimposed on each other. According to this embodiment, even in such a case where the images are captured while a relative position relationship between an object to be captured and an image pickup element is being varied whereby parts of an object image overlap among the partial images, the images can be acquired using only a small memory capacity and with a small amount of calculation.

Still another embodiment of the present invention relates to an image acquiring apparatus. This apparatus comprises: an image pickup unit which acquires an object image as a plurality of partial images; and a calculation unit which calculates, for each of the plurality of partial images, a characteristic quantity that characterizes a direction of lines of each partial image or a characteristic quantity that characterizes each partial image as a single physical quantity. The calculation unit constructs the object image into a single piece of entire image by use of the characteristic quantities for each partial image or the calculation unit constructs a characteristic quantity obtained when the object image is constructed into a single piece of entire image by use of the characteristic quantities for each partial image.

The “image pickup unit” may be provided with a line sensor and may acquire “partial images” by varying a relative position relationship between an object to be captured and an image pickup element. According to this embodiment, the images can be acquired using only a small memory capacity and with a small amount of calculation required.

Still another embodiment of the present invention relates also to an image acquiring apparatus. This apparatus comprises: an image pickup unit which acquires an object image as a plurality of partial images; and a calculation unit which calculates, for each of a plurality of divided regions along a predetermined direction for each region, a characteristic quantity that characterizes a direction of lines of each region or a characteristic quantity that characterizes each region as a single physical quantity. The calculation unit utilizes the characteristic quantity of each partial image so as to construct the object image into a single piece of entire image. The calculation unit constructs the object image into a single piece of entire image by referring to a correspondence between the groups of characteristic quantities relative to partial images, or the calculation unit constructs a characteristic quantity obtained when the object image is constructed into a single piece of entire image by referring to a correspondence between the groups of characteristic quantities relative to partial images. According to this embodiment, the images can be acquired using only a small memory capacity and with a small amount of calculation.

When parts of the object image overlap between the partial images, the calculating unit may join the partial images together so that corresponding parts of the groups of characteristic quantities between the partial images are superimposed on each other. According to this embodiment, even in such a case where the images are captured while a relative position relationship between an object to be captured and an image pickup element is being varied and then parts of an object image overlap among the partial images, the images can be acquired using only a small memory capacity and with a small amount of calculation.

Still another embodiment of the present invention relates to a verifying method. This method comprises: acquiring an object image for verification, as a plurality of partial images; calculating, for each of the plurality of partial images, a characteristic quantity that characterizes a direction of lines of each partial image or a characteristic quantity that characterizes each partial image as a single physical quantity; and verifying characteristic quantities of partial images that constitute the object image against characteristic quantities of partial images, corresponding to said partial images, that constitute a reference image. According to this embodiment, the images can be verified using only a small memory capacity and with a small amount of calculation.

Still another embodiment of the present invention relates also to a verifying method. This method comprises: acquiring an object image for verification, as a plurality of partial images; dividing each of the plurality of partial images into a plurality of regions along a predetermined direction; calculating, for each of the plurality of divided regions, a characteristic quantity that characterizes a direction of lines of each region or a characteristic quantity that characterizes each region as a single physical quantity and generating, for each of the plurality of partial images, a group of characteristic quantities along the predetermined direction; and verifying a group of characteristic quantities of partial images that constitute the object image against a group of characteristic quantities of partial images, corresponding to said partial images, that constitute a reference image. According to this embodiment, the images can be verified using only a small memory capacity and with a small amount of calculation.

Still another embodiment of the present invention relates to a verifying apparatus. This apparatus comprises: an image pickup unit which acquires an object image for verification, as a plurality of partial images; a calculation unit which calculates, for each of the plurality of partial images, a characteristic quantity that characterizes a direction of lines of each partial image or a characteristic quantity that characterizes each partial image as a single physical quantity; and a verification unit which verifies characteristic quantities of partial images that constitute the object image against characteristic quantities of partial images, corresponding to said partial images, that constitute a reference image. According to this embodiment, the images can be verified using only a small memory capacity and with a small amount of calculation.

Still another embodiment of the present invention relates also to an image acquiring apparatus. This apparatus comprises: an image pickup unit which acquires an object image for verification, as a plurality of partial images; a calculation unit which calculates, for each of the plurality of partial images, a characteristic quantity that characterizes a direction of lines of each region or a characteristic quantity that characterizes each region as a single physical quantity and which generates, for the each of the plurality of partial images, a group of characteristics along the predetermined direction; and a verification unit which verifies a group of characteristic quantities of partial images that constitute the object image against a group of characteristic quantities of partial images, corresponding to said partial images, that constitute a reference image. According to this embodiment, the images can be verified using only a small memory capacity and with a small amount of calculation.

It is to be noted that any arbitrary combination of the above-described structural components as well as the expressions according to the present invention changed among a method, an apparatus, a system, a computer program, a recording medium and so forth are all effective as and encompassed by the present embodiments.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a function block of a verification apparatus according to a first embodiment of the present invention.

FIG. 2 is a flowchart showing a processing for generating reference data in a verification apparatus according to a first embodiment of the present invention.

FIG. 3 shows a fingerprint image picked up in a first embodiment of the present invention.

FIG. 4 illustrates a vector V(y0) that represents a feature in a linear region of FIG. 3.

FIG. 5 shows a distribution of characteristic quantities obtained when the image of FIG. 3 is sliced for each linear region.

FIG. 6 is a flowchart showing an authentication processing of a verification apparatus according to a first embodiment of the present invention.

FIG. 7 is an illustration in which a distribution of characteristic quantities of reference data are superimposed on that of data to be authenticated in the first embodiment.

FIG. 8 illustrates an example in which an image is sliced perpendicularly according to a second embodiment of the present invention.

FIG. 9 illustrates a distribution of characteristic quantities in their respective linear regions shown in FIG. 8.

FIG. 10 illustrates an example of an image sliced in the direction of 45° according to a second embodiment of the present invention.

FIG. 11 illustrates a distribution of characteristic quantities in their respective linear regions shown in FIG. 10.

FIG. 12 illustrates an example in which the iris part of an eye is divided into concentric areas according to a third embodiment of the present invention.

FIG. 13 illustrates a distribution of characteristic quantities in their respective concentric areas shown in FIG. 12.

FIG. 14 is a flowchart to explain a processing for generating reference data used in a verification apparatus according to a fourth embodiment of the present invention.

FIG. 15 illustrates a fingerprint image captured and a distribution of characteristic quantities when the captured image is sliced into linear regions, according to a fourth embodiment of the present invention.

FIG. 16 is a flowchart to explain a processing for generating reference data used in a verification apparatus according to a fifth embodiment of the present invention.

FIG. 17 illustrates distributions of characteristic quantities obtained when a data acquisition region set in a fingerprint image and the image in said region are sliced into each linear regions, according to a fifth embodiment of the present invention.

FIG. 18 illustrates a function block of a verification apparatus according to a sixth embodiment of the present invention.

FIG. 19 is an example of images taken by an image pickup unit according to a sixth embodiment of the present invention.

FIG. 20 is a flowchart in a sixth embodiment showing an operation, carried out by a verification apparatus, for recognizing a region where an object is located.

FIG. 21 is a figure illustrating that the image captured by an image pickup unit of FIG. 18 at time t₁ and an image captured thereby at time t₂ are superimposed on each other and a difference in extracted distribution of characteristic quantities between an image data D1 and an image data D2 and a difference in in-region distribution of characteristic quantities therebetween.

FIG. 22 illustrates a function block of a verification apparatus according to a seventh embodiment of the present invention.

FIG. 23 illustrates an arrangement of streams generated by a generator shown in FIG. 22.

FIG. 24 illustrates a structure of a reproducing apparatus which reproduces and displays the streams shown in FIG. 23.

FIG. 25 illustrates a function block of a verification apparatus according to an eighth embodiment of the present invention.

FIG. 26 illustrates a method by which a posture identifying unit of FIG. 25 identifies the posture of an object.

FIG. 27 illustrates a function block of an environment controlling apparatus according to a ninth embodiment of the present invention.

FIG. 28 is an example of display by an information monitor of FIG. 27.

FIG. 29 illustrates an example according to a tenth embodiment of the present invention where characteristics are extracted in a plurality of directions.

FIG. 30 illustrates a modification to the tenth embodiment of the present invention where the characteristics are extracted in a plurality of directions.

FIG. 31 is a flowchart to explain a processing, according to a tenth embodiment of the present invention, for verifying a plurality of images.

FIG. 32 is a figure to explain an example in the tenth embodiment where one image of an object to be verified has characteristics in a plurality of directions whereas the other image of the object has characteristics in a single direction.

FIG. 33 is a figure to explain an example in the tenth embodiment where a plurality of images to be verified have characteristics in a plurality of directions.

FIG. 34 illustrates an example in which the characteristics are extracted in a plurality of directions by rotating an image.

FIG. 35 illustrates an example in which the characteristics for a plurality of directions are extracted without rotating an image.

FIG. 36 is a flowchart explaining an image acquiring processing according to an eleventh embodiment of the present invention.

FIG. 37 illustrates a process according to an eleventh embodiment of the present invention where the characteristics of an entire image is produced from partial images.

FIG. 38 illustrates an example where the characteristics are compared and verified for the respective partial images according to a twelfth embodiment of the present invention.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

### First Embodiment

In a first embodiment, a vector characterizing the directions of ridge or furrow lines in a linear region along a line perpendicular to a reference direction on a fingerprint image is obtained, and the component of such a vector is calculated. Then the distribution in the reference direction of the component is determined and compared with the similarly determined distribution of enrolled data to verify the match of the fingerprint images.

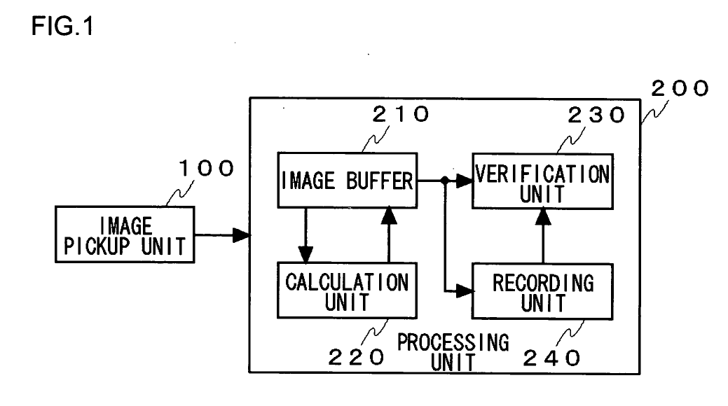

FIG. 1 is a function block of a verification apparatus 1 according to a first embodiment of the present invention. In terms of hardware, each block shown in FIG. 1 can be realized by various types of elements, such as a processor and RAM, and various types of devices, such as a sensor. In terms of software, it can be realized by computer programs or the like, but drawn and described herein are function blocks that are realized in cooperation with those. Thus, it is understood by those skilled in the art that these function blocks can be realized in a variety of forms such as by hardware only, software only or the combination thereof.

The verification apparatus 1 comprises an image pickup unit 100 and a processing unit 200. The image pickup unit 100, in which CCD (Charge Coupled Device) or the like is used, takes an image of a user's finger and outputs it to the processing unit 200 as image data. For instance, if the image is to be captured by a mobile device equipped with a line sensor such as CCD, a fingerprint image may be collected by requesting the user to hold his/her finger on a sensor and then sliding the finger in a perpendicular direction.

The processing unit 200 includes an image buffer 210, a calculation unit 220, a verification unit 230 and a recording unit 240. The image buffer 210 is a memory area which is used to store temporarily image data inputted from the image pickup unit 100 and which is also utilized as a working area for the calculation unit 220. The calculation unit 220 performs various types of computation (described later) on the image data in the image buffer 210. The verification unit 230 compares characteristic quantities of image data, to be authenticated, stored in the image buffer 210 with characteristic quantities of image data enrolled in the recording unit 240, and decides whether the fingerprint belongs to the same person or not. The recording unit 240 stores characteristic quantities of a fingerprint whose image has been taken in advance. Data on a single person are usually registered when used for a mobile-phone or the like. However, if the verification apparatus 1 is used for a gate of a room or the like, data on a plurality of individuals will be enrolled instead.

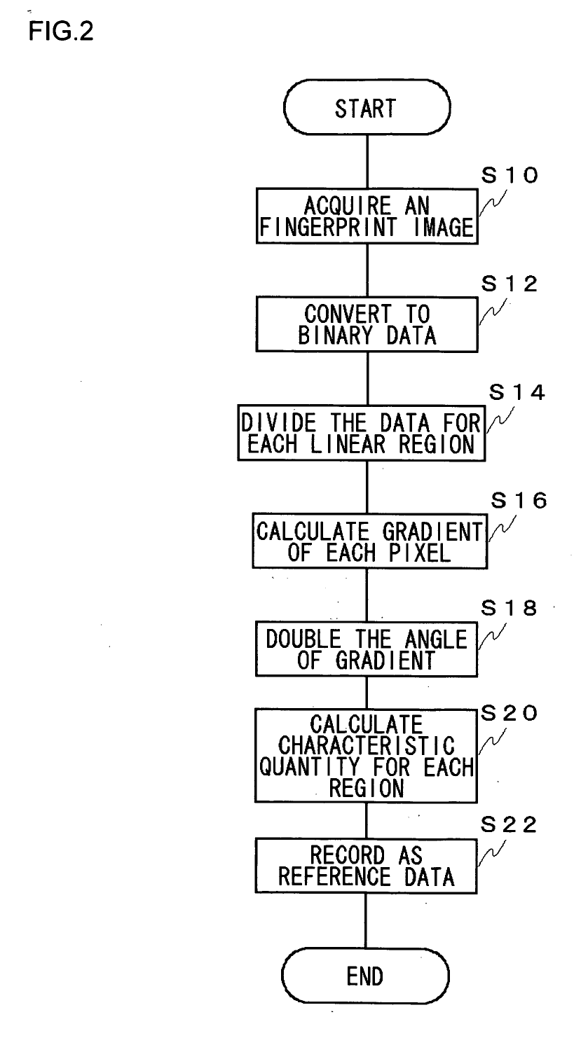

FIG. 2 is a flowchart showing a processing for generating reference data in the verification apparatus 1 according to the first embodiment. This reference data are such that a fingerprint image of an individual to be authenticated is registered beforehand as a distribution of a predetermined directional component, namely, for example, the distribution of characteristic quantities that characterize the directions of ridge or furrow lines in the linear region.

First, the image pickup unit 100 takes an image of a finger held by a user, converts the captured image into electric signals and outputs them to the processing unit 200. The processing unit 200 acquires the electric signals as image data and stores them temporarily in the image buffer 210 (S10). The calculation unit 220 converts the image data into binary data (S112). For example, a decision is made in a manner such that a value which is brighter than a predetermined value is regarded white and a value which is darker than the predetermined value is regarded black. And the white is represented by “1” or “0” and the black is represented by “0” or “1”.

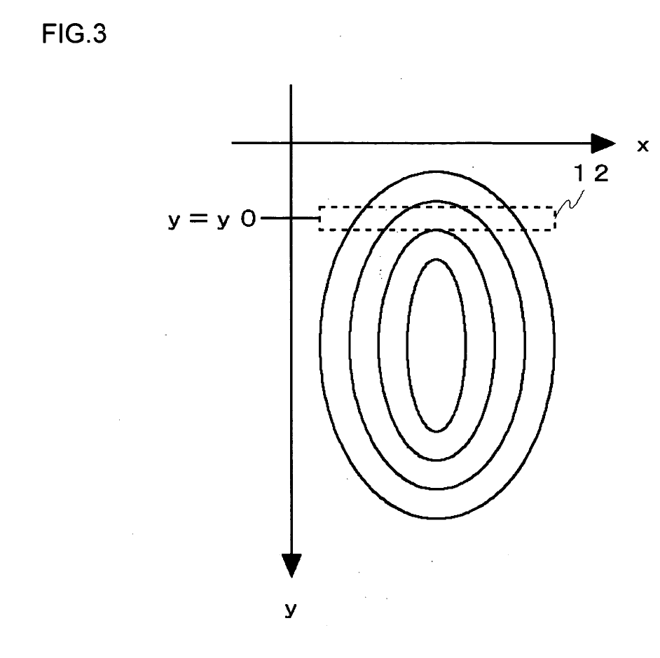

Then, the calculation unit 220 divides the binarized image data for each of linear regions (S14). FIG. 3 shows a fingerprint image captured in the first embodiment. In FIG. 3, the calculation unit 220 forms a linear region 12 having the longer sides in the X direction and the shorter sides in the Y direction. It is preferable that this linear region is such that the shorter side is set with one or three pixels. There are formed a plurality of linear regions in the Y direction, namely, in the longitudinal direction of a finger so as to divide the fingerprint image into a plurality of regions.

Then, the calculation unit 220 calculates the gradient of each pixel (S16). As a method for calculating the gradient, the method described in the literature “Tamura, Hideyuki, Ed., Computer Image Processing, pp. 182-191, Ohmsha, Ltd.” can be used.

Hereinbelow, the method will be briefly described. In order to calculate the gradients for digital images to be treated, it is necessary to calculate first-order partial differential equations in both the x direction and y direction.
Δₓf(i,j)≡{f(i+1,j)−f(i−1,j)}/2 (1)
Δ_{y}f(i,j)≡{f(i,j+1)−f(i,j−1)}/2 (2)

In a difference operator for digital images, the derivative values at a pixel (i, j) is defined by the linear combination of gray values of 3×3 neighboring pixels with the center at (i, j), namely, f(i±1,j±1). This means that the calculation to obtain derivatives of images can be realized by the spatial filtering using a 3×3 weighting matrix. Various types of difference operators can be represented by 3×3 weighting matrices. In the following (3), considered are 3×3 neighbors with the center at (i, j).
f(i−1,j−1) f(i,j−1) f(i+1,j−1)
f(i−1,j) f(i,j) f(i+1,j) (3)
f(i−1,j+1) f(i,j+1) f(i+1,j+1)
The difference operator can be described by a weighting matrix for the above (3).

For example, the first-order partial differential operators, in the x and y directions, defined in Equations (1) and (2) are expressed by following matrices (4).

$$( \begin{matrix}0 & 0 & 0 \\ - 1 / 2 & 0 & 1 / 2 \\ 0 & 0 & 0\end{matrix} ) and ( \begin{matrix}0 & - 1 / 2 & 0 \\ 0 & 0 & 0 \\ 0 & 1 / 2 & 0\end{matrix} ) \qquad ( 4 )$$

That is, in a rectangular area represented by (3) and (4) of 3×3, the pixel values are multiplied by matrix element values for the corresponding positions, respectively, and the summation thereof is calculated, which in turn will coincide with the right-hand sides of Equations (1) and (2).

The magnitude and the direction of a gradient are obtained as the following Equations (5) and (6), respectively, after the gradient is subjected to the spatial filtering by the weighting matrix of Equation (4) and calculating partial differentials defined in the Equations (1) and (2) in the x and y directions.
|∇f(i,j)|=\sqrt{Δₓf(i,j)²+Δ_{y}f(i,j)²} (5)
θ=tan⁻{Δ_{y}f(i,j)/Δₓf(i,j)} (6)

The Roberts operator, Prewitt operator, Sobel operator or the like is available as the above-mentioned difference operator. The gradients and so forth can be calculated in a simplified manner using such a difference operator and, anti-noise measures can also be taken.

Then the calculation unit 220 obtains a pair of values such that the direction obtained in Equation (6), namely, the angle of a gradient vector is doubled (S18). Although the direction of the ridge or furrow line of a fingerprint is calculated using the gradient vector in the present embodiment, the points whose ridge or furrow lines face in the same direction will not have the same gradient vector values. For this reason, the gradient vector is rotated so that an angle formed by the gradient vector and the coordinate axes becomes double, and then a single pair of values composed of an x component and a y component is obtained. Thereby, the ridge or furrow lines in the same direction can be represented by the unique pair of values having the same components. For example, 450 is the exactly opposite direction of 225° and vice versa. Now, if doubled, these doubled angles 90° and 450° will be the unique directions. Here, a pair of values composed of an x component and a y component is one in which a vector is rotated by a certain rule in a certain coordinate system. In this patent specification, such values will also be described as a vector.

Since the direction of ridge or furrow line in an area containing a fingerprint image varies widely at a localized area, an average will be taken within a certain range as will be described later. In that case, if the angle of a gradient is doubled so as to become the unique vector as described above, an approximate value of the direction of the ridge or furrow line can be obtained by taking the average after the thus doubled angles have been simply added together. Otherwise, the summation of two gradient vectors, which are opposite in direction they face, results in “0”, so that the simple addition does not render any meaningful result. In this case, a complicated calculation has to be done to compensate for the fact that 180° and 0° are equivalent to each other.

Then the calculation unit 220 adds up the vectors obtained for each pixel at each linear region so as to obtain an averaged vector. This averaged vector serves as a characteristic quantity (S20). This characteristic quantity is a value that indicates an average of the direction of the ridge or furrow line, and it is uniquely set for each region.

At this time, if white points alone or black points alone occur consecutively, a state continues in which the gradient cannot be defined. Thus, if this continues exceeding a predetermined number of points, such a portion may be excluded from the averaging processing. This predetermined number may be determined on an experimental basis.

Finally, the calculation unit 220 obtains the x component and the y component acquired for each region and records them as the reference data in the recording unit 240 (S22). The calculation unit 220 may record them after the distribution of x components and y components of said vector has been subjected to a smoothing processing as described later.

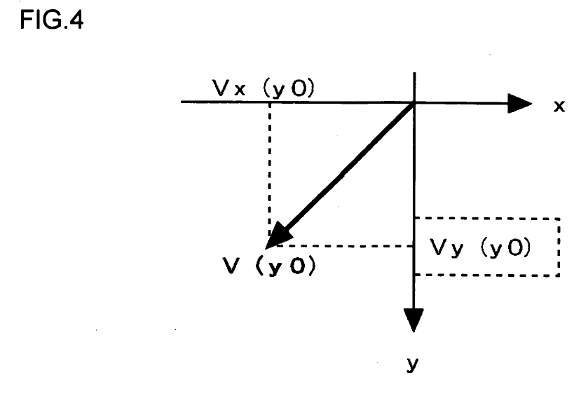

FIG. 4 illustrates a vector V(y0) that represents a feature in the linear region 12 of FIG. 3. The linear region 12 is a region cut out along y=y0 on the coordinate plane shown in FIG. 3. FIG. 4 shows a vector V=(Vx, Vy) that represents a feature of a ridge or furrow line in the area. Vx(y0) and Vy(y0) represent the end points intersecting with the x axis and y axis on the rectangular coordinates, respectively, with the starting point of the vector V(y0) as the origin. Used as a characteristic quantity is the value obtained after the angle of the gradient vector of each pixel as described above is doubled and then averaged.

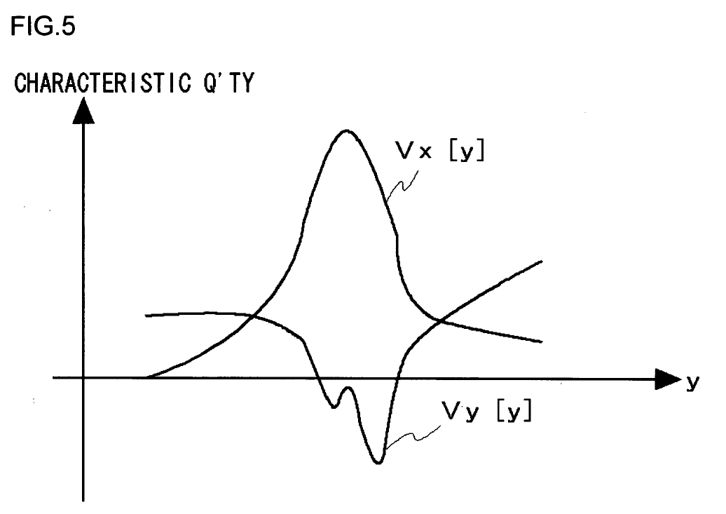

FIG. 5 shows a distribution of characteristic quantities obtained when the image of FIG. 3 is sliced for each linear region. That is, FIG. 5 shows the distribution of characteristic quantities acquired when the image is scanned in the y direction on the coordinate plane shown in FIG. 3, namely, in the direction vertical to the slicing direction of the linear region. The horizontal axis of FIG. 5 corresponds to the y axis of FIG. 3 whereas the vertical axis of FIG. 5 shows the characteristic quantity of each region. In FIG. 5, the vector characterizing each region is represented by an x component and a y component as shown in FIG. 4. The calculation unit 220 can obtain, from a fingerprint image to be enrolled, the distribution of x component and the y component of such a vector characterizing each region and store them as the reference data in the recording unit 240.

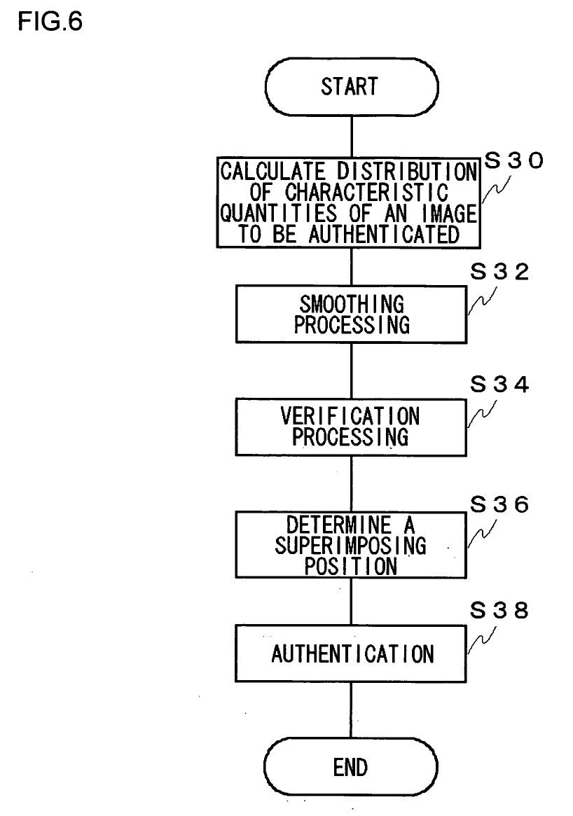

FIG. 6 is a flowchart showing an authentication processing of a verification apparatus 1 according to the first embodiment of the present invention. First, the image pickup unit 100 takes an image of a finger held by a user requesting a verification, converts the captured image into electric signals and outputs them to the processing unit 200. The processing unit 200 performs the same processings as Step S12 through Step S20 of FIG. 2 on the acquired image so as to calculate a distribution of characteristic quantities of image data which are the data to be authenticated (S30).

The calculation unit 220 has the distribution of characteristic quantities undergo a smoothing processing (S32). For example, some points in the vicinity of feature points or the like are averaged. The degree of smoothing to be done depends on an application to be used, and the optimum value therefor may be determined on an experimental basis.

Next, the verification unit 230 compares the distribution of characteristic quantities of reference data with that of data to be authenticated (S34). This verification processing is performed in a manner such that one of the distributions thereof is fixed and the other distribution thereof is slid gradually. And a pattern that matches most will be obtained. The entire pattern may undergo the pattern matching processing. However, in order to reduce the amount of calculation, a processing may be such that feature points in the both distributions are detected and, with points that match therein being the centers, only some patterns surrounding the centers undergo the pattern matching processing. For example, a point at which the maximum value of x component occurs, a point bearing a value “0”, a point whose derivative is “0”, or a point whose slope or gradient is steepest may be used as a marked-out point.

The pattern matching can be carried out by detecting the difference between each component of the reference data and the data to be authenticated about each point on the y axis. For example, it can be done by calculating an energy E of the matching defined by the following Equation (7).
E=Σ\sqrt{ΔVx²+ΔVy²} (7)

The error ΔVx of x component and the error ΔVy of y component in the both distributions are each squared and added together and then the square root thereof is calculated. Since this x component and y component are primarily components of a vector, the error in magnitude of vector can be obtained. Such the errors are added in the direction of y axis, thus resulting as a matching energy E. Hence, the larger the energy E, the less approximated image it becomes whereas the smaller the energy E, the more approximated image it becomes. And the pattern whose matching energy E is minimum will be a superimposing position (S36). The pattern matching method is not limited thereto, and it may be, for example, such that the absolute value of the error ΔVx of x component and the absolute value of the error ΔVy of y component in the both distributions are added together. The method may also be such that a verification method exhibiting high accuracy is experimentally obtained and implemented.

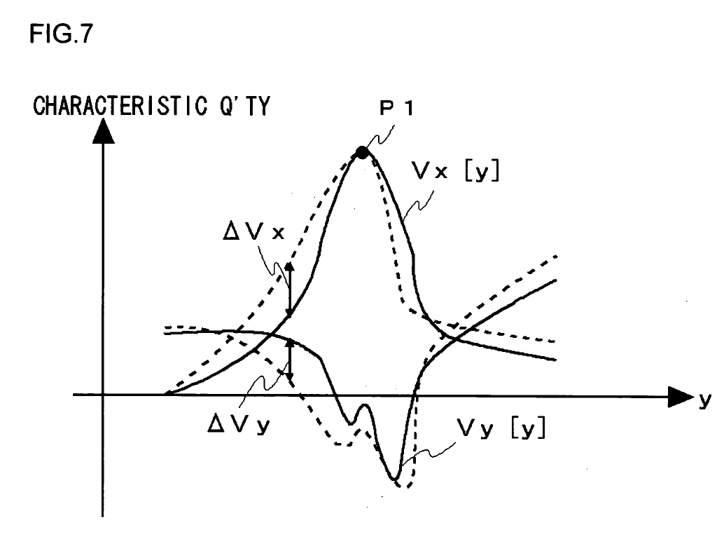

FIG. 7 shows how the distribution of characteristic quantities of reference data are superimposed on that of data to be authenticated in the first embodiment. In FIG. 7, the distribution of reference data is represented by the solid lines whereas that of data to authenticated is represented by dotted lines. In the example shown in FIG. 7, the maximum values of x components in the both distributions are first detected. Then the pattern matching is carried out in a first position where the maximum values p1 agree and in a second position where either of the distributions is shifted by a few points from the first position, and a position matched up most desirably is assumed as a superimposing position.

The verification apparatus 230 compares a calculated matching energy E with a predetermined threshold value with which to determine the success or failure of an authentication. And if the matching energy E is less than the threshold value, it is judged that the verification between the reference data and the data to be authenticated has been successful (S38). Conversely, if the matching energy E is greater than or equal to the threshold value, the authentication is denied. If a plurality of pieces of reference data are enrolled, the aforementioned processing will be carried out respectively between the plurality of pieces of reference data and the data to be authenticated.

As described above, according to the first embodiment, an image of biological information such as a fingerprint is divided into a plurality of predetermined regions, and a value that characterizes each region is used for a verification processing between the reference image and the image to be authenticated. As a result, the authentication processing can be carried out with a small amount of memory capacity. The amount of calculation can also be reduced, thus making the authentication processing faster. Thus, applying the first embodiment to the authentication processing of mobile devices powered by batteries or the like gives rise to the reduced area of a circuit and the overall power saving. Since the characteristic quantity is obtained for each of the linear regions, the structure realized by the first embodiment is suitable for the verification of fingerprint images captured by a line sensor or the like. The characteristic quantities of each pixel are averaged for each region and the distribution of the average characteristic quantities undergoes the smoothing processing, thus realizing noise-tolerant verification apparatus and method. Since the averaging processing is executed in the linear region, whether a finger in question belongs to the same person or not can be verified even if the finger is slid from side to side. Differing from the minutiae-method, the enrollment and authentication can be effectively and properly performed even if a fingerprint image containing strong noise is inputted.

### Second Embodiment

In the above first embodiment, a method for dividing an image in one direction to-obtain a linear region has been described. In a second embodiment of the present invention, a description will be given of an example of methods for dividing in a plurality of directions. For example, an image is sliced in two directions.

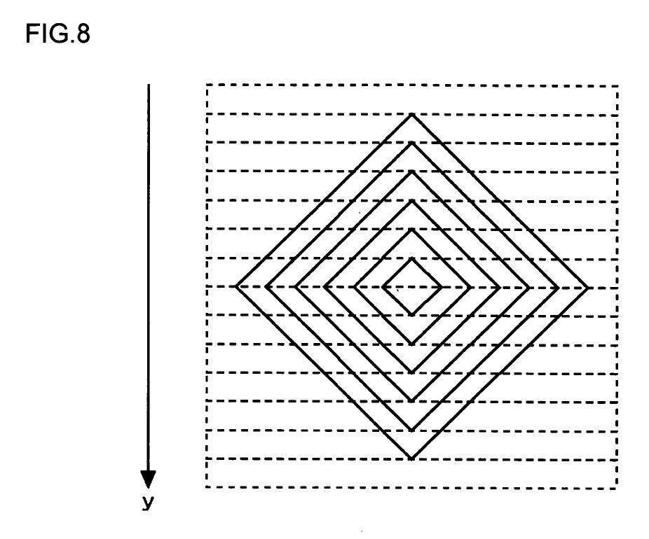

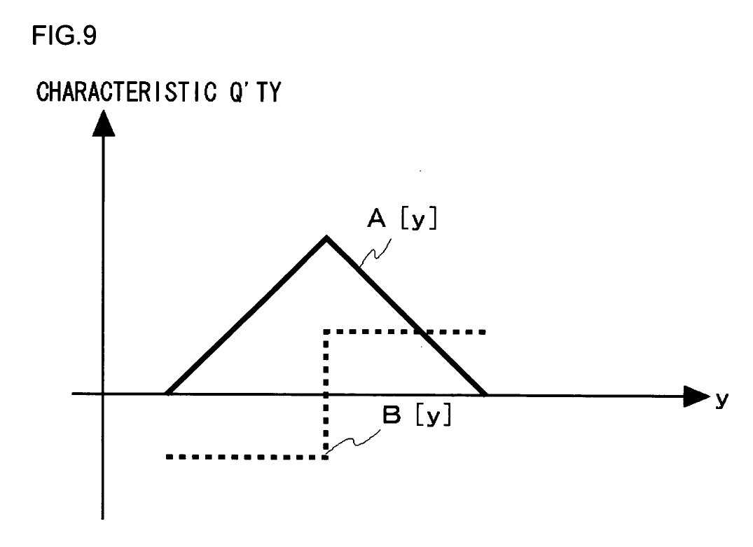

The structure and operation of a verification apparatus 1 according to the second embodiment are the same as those of the verification apparatus 1 according to the first embodiment shown in FIG. 1, and therefore the description thereof is omitted. FIG. 8 illustrates an example in which an image is sliced perpendicularly according to the second embodiment. It is to be noted here that an image to be verified may not only be a fingerprint image as described above but may also be an iris image or any other image representing biological information. For convenience of explanation, FIG. 8 shows an image with a striped pattern. FIG. 9 illustrates a distribution of characteristic quantities in their respective linear regions shown in FIG. 8. Shown is the distribution of characteristic quantities A and B, which characterize the respective linear regions, in their y direction, namely, the perpendicular direction.

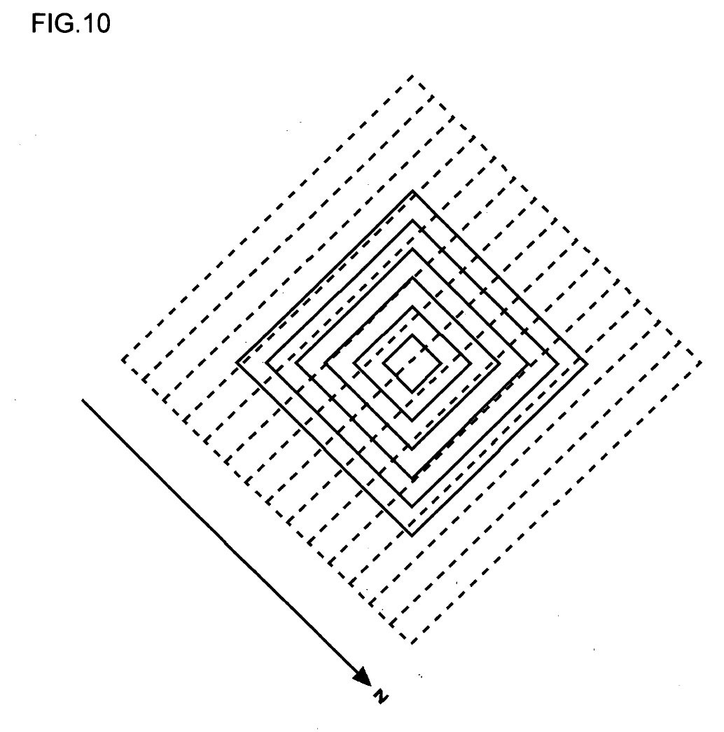

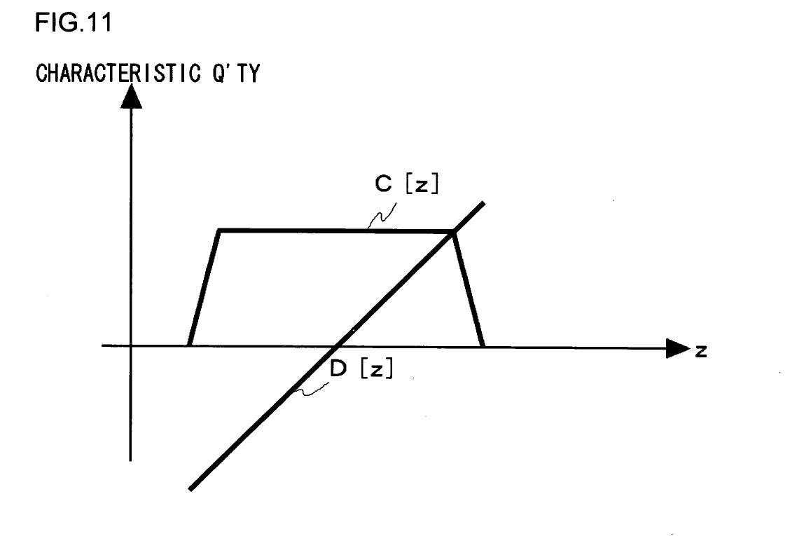

FIG. 10 illustrates an example of an image sliced in the direction of 45° according to the second embodiment. In FIG. 10, the same image as shown in FIG. 8 is sliced at an incline of 45 degrees. FIG. 11 illustrates a distribution of characteristic quantities in their respective linear regions shown in FIG. 10. Shown is the distribution of characteristic quantities C and D, which characterize the respective linear regions, in their z direction, or the 45-degree direction. In this manner, an image is sliced in two directions, and the characteristics of the image are represented by the four kinds of characteristic quantities A, B, C and D. The processing to generate reference data and the processing to authenticate inputted data according to the second embodiment may be carried out the same way as those of the first embodiment explained in FIG. 2 and FIG. 6, using these characteristic quantities. In this case, there are a plurality of matching energies E calculated from their respective directions, and therefore the verification unit 230 may, for instance, determine whether to perform an identity verification or not, by obtaining their average value.

It should be understood here that the characteristic quantities are not limited to the x component and y component of a vector which characterizes the ridges or furrows in a linear region as explained in the first embodiment. For example, they may be the gradation, luminance or color information of an image or other local image information or any numerical value, such as scalar quantity or vector quantity, differentiated or otherwise calculated from such image information.

According to the second embodiment, an image may be picked up by a one-dimensional sensor like a line sensor, taken in by an image buffer 210 and sliced in two or more directions, or a two-dimensional sensor may be used. The examples of two or more directions of slicing may generally include vertical, horizontal, 45-degree and 135-degree directions, but, without being limited thereto, they may be arbitrary directions. Moreover, the combination of two or more directions of slicing is not limited to vertical and 45-degree directions, but it may be set arbitrarily.

As described above, according to the second embodiment, a higher accuracy of verification than that according to the first embodiment can be achieved by the use of a plurality of directions for slicing an image to obtain linear regions. In the second embodiment, too, it is not necessary to generate an image from another image as in the minutiae method, so that this arrangement requires memory capacity only enough to store an original image. Hence, a highly accurate verification can be carried out with smaller memory capacity and smaller amount of calculation.

### Third Embodiment

In the first and second embodiments, examples of verification methods using linear forms for sliced linear regions have been described. The form is not limited to linear, but it may be nonlinear such as curved, closed-curved, circular or concentric. In a third embodiment of the present invention, a description will be given of a method for verification of iris images as a representative example of dividing an image into nonlinear regions.

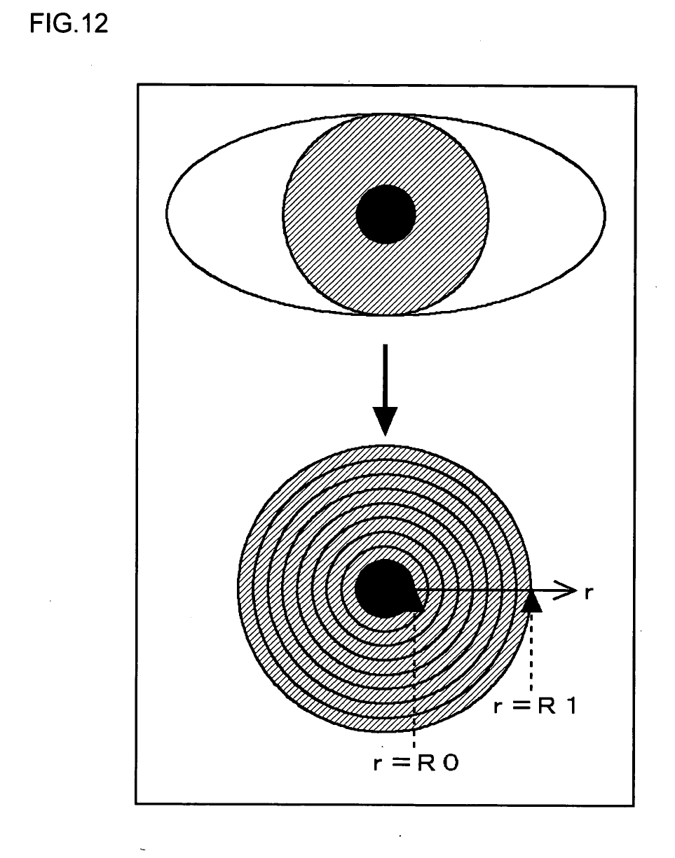

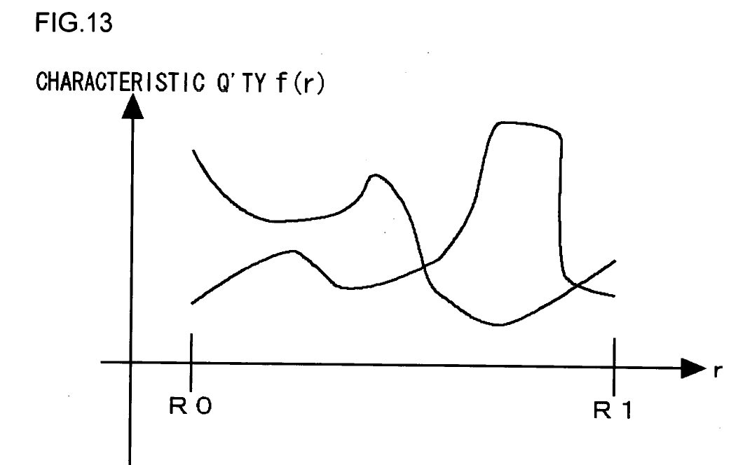

The structure and operation of a verification apparatus 1 according to the third embodiment are the same as those of the verification apparatus 1 according to the first embodiment shown in FIG. 1, and therefore the description thereof is omitted. FIG. 12 illustrates an example in which the iris part of an eye is divided into concentric areas according to the third embodiment. In FIG. 12, as the linear regions there are provided the concentrically divided areas. FIG. 13 illustrates a distribution of characteristic quantities in their respective concentric areas shown in FIG. 12. The distribution in the radial direction r of values characterizing the respective areas is derived. The processing to generate reference data and the processing to authenticate inputted data according to the third embodiment can be carried out the same way as those of the first embodiment explained in FIG. 2 and FIG. 6, using these characteristic quantities.

For the iris, the verification processing as explained in FIG. 6 is simpler. In the processing, the distributions of the two characteristic quantities are superimposed on each other between the authentication data and the reference data so that there are matches at the boundary R0 between pupil and iris and at the boundary R1 between iris and white of eye. However, since the size of the pupil changes with the environmental brightness, it is necessary to change the distance between the boundary R0 and the boundary R1 of the authentication data to meet that of the reference data.

As described above, according to the third embodiment, verification of an iris image can be performed with smaller memory capacity and smaller amount of computation. Since characteristic quantities are obtained by averaging the gradient vectors or the like of the pixels in the concentric circular areas, verification can be carried out with high accuracy even when the eye position is rotated in relation to the reference data. This is comparable to the trait of fingerprint image identification in the first embodiment which can well withstand horizontal slides of a finger. Even when not all of the iris is picked up because it is partly covered with the eyelid, a relatively high level of accuracy can be achieved by performing a verification using a plurality of regions near the pupil.

It is to be noted that when a half of the iris is to be used for verification, the division may be made into half-circular areas instead of concentric areas. And the technique of dividing an image into nonlinear regions like this is not limited to the iris image, but may be applicable to the fingerprint image. For example, the center of the whorls of a fingerprint may be detected and from there the fingerprint may be divided into concentric circles outward.

### Fourth Embodiment

In the second embodiment, an example has been described where an image is divided along a plurality of directions and therefore types of the characteristic quantities to be verified-are increased. In a fourth embodiment of the present invention, a description will be given of an example where, in order to improve the verification accuracy, the image regions in which missing parts are unlikely to occur at the time of image pickup are set on both a reference image and an image to be authenticated and then the thus set image regions are verified each other so that the images on the same region can always be verified against each other.

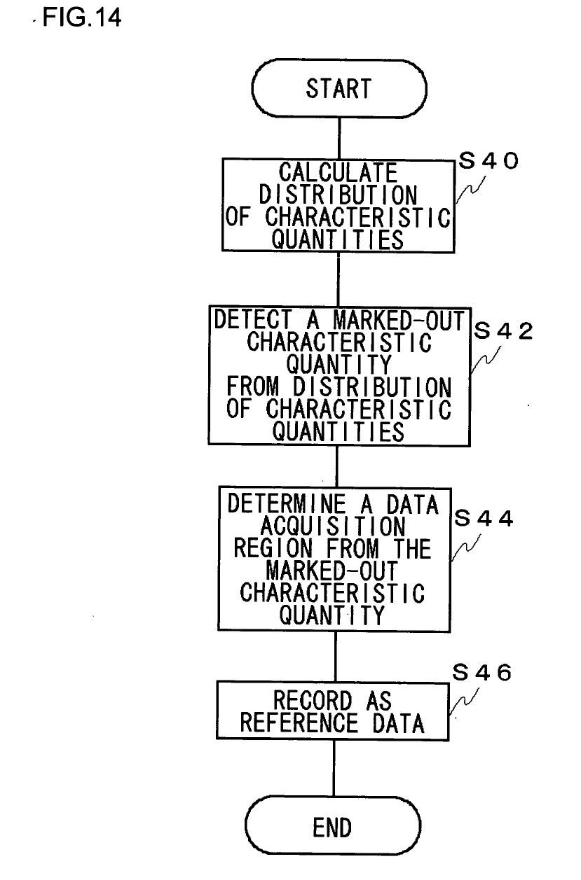

The structure and operation according to the fourth embodiment are basically the same as those of the verification apparatus 1 according to the first embodiment as shown in FIG. 1. Hereinbelow, a description will be given of what differs from those of the verification apparatus 1 of the first embodiment. FIG. 14 is a flowchart to explain a processing for generating reference data used in a verification apparatus 1 according to the fourth embodiment. First, an image pickup unit 100 takes an image of a finger held by a user, converts the captured image into electric signals and outputs them to a processing unit 200. The processing unit 200 performs the same processing as in the Steps S12 to S20 shown in FIG. 2 on the acquired image so as to generate a distribution of characteristic quantities for the image data (S40).

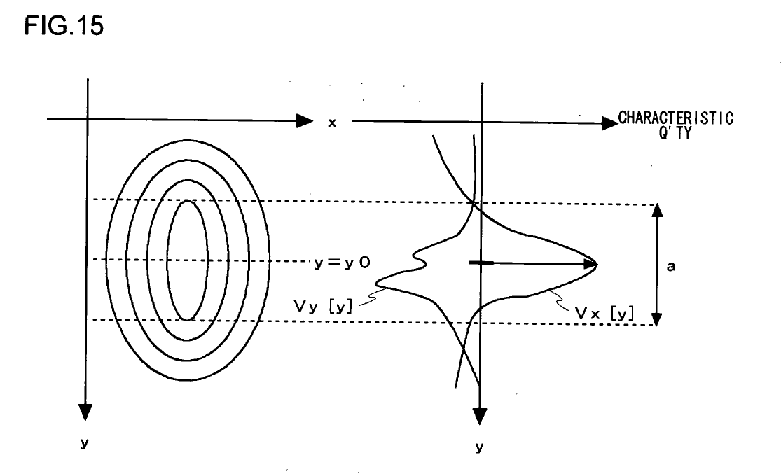

Next, the calculation unit 220 detects a characteristic quantity to be marked out, from this distribution of characteristic quantities (S42). Then a data acquisition region indicative of a region from which data is to be acquired is set based on the thus detected characteristic quantity to be marked out (S44). FIG. 15 illustrates a fingerprint image captured and a distribution of characteristic quantities when the captured image is sliced into linear regions, according to the fourth embodiment. Referring to FIG. 15, the characteristic quantity of each region obtained along the y direction of a captured image is represented by a vector, and the maximum value, on the y-coordinate, among x components of said vector is set as a characteristic quantity to be marked out. Then, based on the value on the y-coordinate which assigns the maximum value in the x components, a certain range above and below the maximum value is set as the range a in the y direction of the data acquisition region. For instance, if the y direction is of image data of 200 pixels, 50 pixels above and 50 pixels below said maximum value as the center may be set as the range a in the y direction.

The calculation unit 220 records, as reference data, the distribution of characteristic quantities obtained when the aforementioned data acquisition region is moved along the y direction (S46). A new distribution of characteristic quantities may be generated along the y direction again in the above data acquisition region. Also, the range to be used in the distribution of characteristic quantities already obtained along the y direction may be set according to the above range a in the y direction.

According to the fourth embodiment, when the authentication processing as shown in FIG. 6 is performed, the data acquisition region is also set, in the similar manner, to an image to be authenticated and the distributions of characteristic quantities for this region are checked against each other.

According to the fourth embodiment as described above, the distribution of characteristic quantities in a range where the missing parts are unlikely to occur in both a reference image and an the image regions to be authenticated are checked against each other so that the images on the same region can always be verified against each other. As a result, the verification accuracy can be improved. That is, since the fingerprint tends to be of vertical stripes in the central portion thereof, the maximum value of x components in the above characteristic amount will appear in the neighborhood of the central portion of the captured fingerprint image if scanned along the y direction. For example, when the finger is slid from the upper position to the lower position or from the lower position to the upper position relative to a sensor mounted horizontally, the image of the tip of finger or the image of the other end thereof may not be taken successfully depending on the direction in which the finger is slid. If either the reference image or the image to verified has a missing part, it is possible that the authentication is determined false even when the processing unit 200 should have determined the person's authentication to be successful. In contrast thereto, it is highly probable that the image of the central portion of a finger can be taken without any missing part. Hence, the probability that the corresponding regions can be verified will be high if the images of the central part of a finger are to be verified. If partial images only in the set range a are used as reference data, the storage capacity can further be reduced.

### Fifth Embodiment

In the second embodiment, an image is divided from a plurality of directions and the types of the characteristic quantities to be verified are increased. In the fourth embodiment, an example was explained where the image regions in which missing parts are unlikely to occur at the time of image pickup are set on both a reference image and an image to be authenticated so that the images on the same region can always be verified against each other. In a fifth embodiment, an example will be described where when an image is divided along a plurality of directions, the distribution of characteristic quantities obtained along a certain direction is utilized when a distribution of characteristic quantities is to be obtained along another direction.

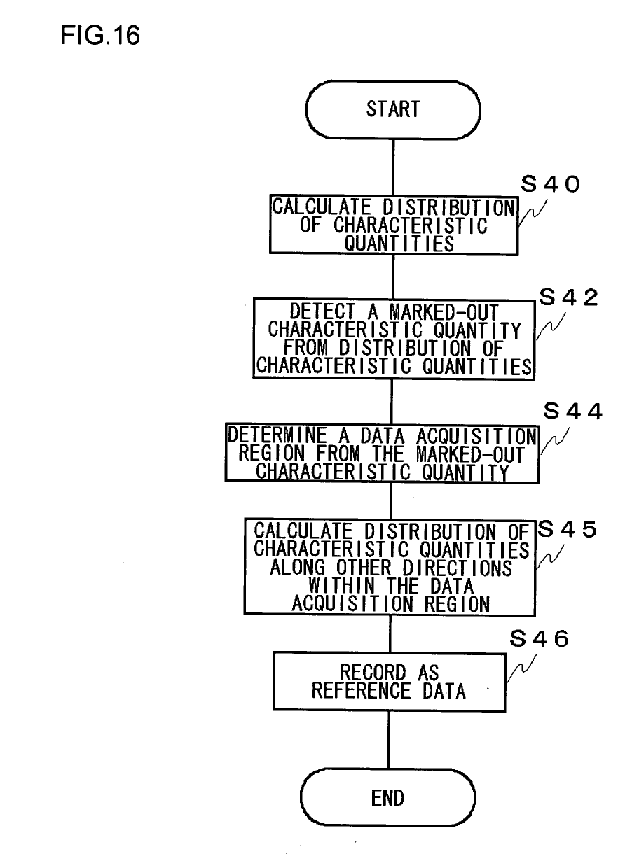

The structure and operation according to the fifth embodiment are basically the same as those of the verification apparatus 1 according to the first embodiment as shown in FIG. 1. Hereinbelow, a description will be given of what differs from those of the verification apparatus 1 of the first embodiment. FIG. 16 is a flowchart to explain a processing for generating reference data used in a verification apparatus 1 according to the fifth embodiment. The processings up to Step S44 in FIG. 16 are the same as those up to Step S44 of FIG. 14.

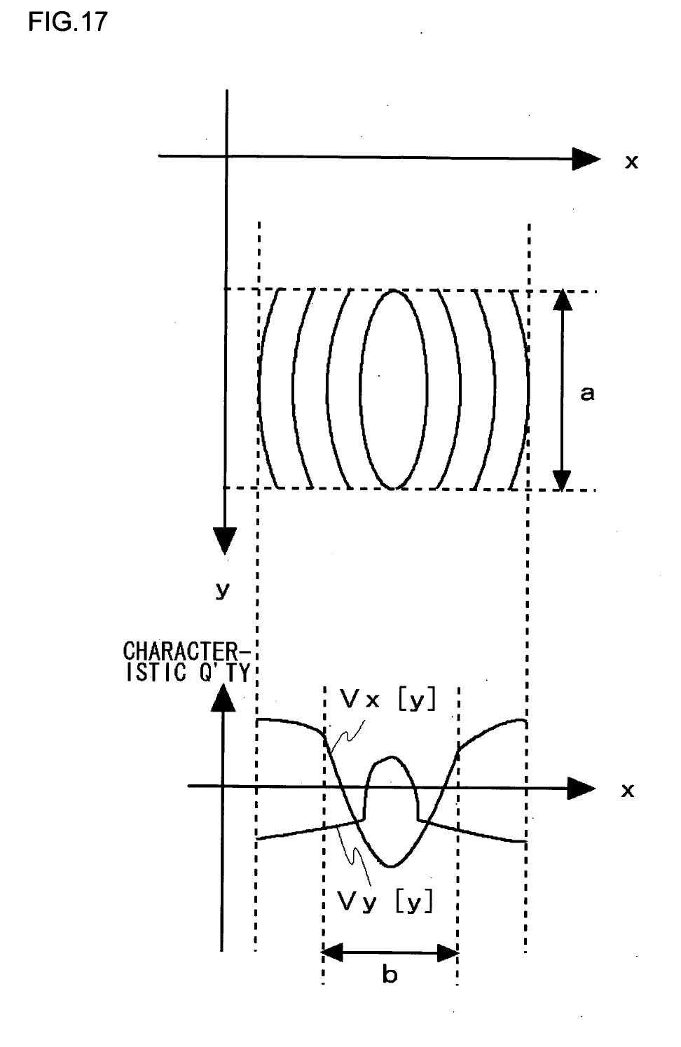

After having set a data acquisition region, the calculation unit 220 generates a distribution of characteristic quantities, in the thus set region, along another direction (S45). FIG. 17 illustrates distributions of characteristic quantities obtained when a data acquisition region set in a fingerprint image and the image in said region are each sliced into linear regions, according to the fifth embodiment. Referring to FIG. 17, the distribution of characteristic quantities is generated along the x direction of the data acquisition region in which the range a is set in the y direction. The calculation unit 220 records a distribution of characteristic quantities obtained along the x direction of said data acquisition region in the recording unit 240 as reference data (S46). Alternatively, a distribution of characteristic quantities obtained along the x direction of said data acquisition region and a distribution of characteristic quantities obtained along the y direction before setting said data acquisition region may be recorded. Still alternatively, a distribution of characteristic quantities obtained along the x direction of said data acquisition region and a distribution of characteristic quantities obtained along the y direction of said data acquisition region may be recorded.

According to the fifth embodiment, when an authentication processing shown in FIG. 6 is performed, the distribution of characteristic quantities is generated similarly for an image to be authenticated, along the x direction of a data acquisition region so as to be checked against the recorded distribution of characteristic quantities. Here, the distribution of characteristic quantities obtained along the y direction of a fingerprint image or the distribution of characteristic quantities obtained along the x direction of a data acquisition region may also be used for the verification.

According to the fifth embodiment as described above, when an image is divided along a plurality of directions, by making use of the distribution of characteristic quantities obtained along a certain direction a distribution of characteristic quantities is obtained along another direction. Hence, the highly accurate distributions of characteristic for the other directions can be obtained. That is, when the distributions of characteristic quantities are obtained along the other directions, parts that are unlikely to be missed in the captured fingerprint image can be used as the reference data and the data to be authenticated.

In the fifth embodiment, a characteristic quantity to be marked out may be further detected from the distribution of characteristic quantities obtained along the x direction of a data acquisition region. Then, based on this characteristic quantity, a new data acquisition region will be determined. For example, referring to FIG. 17, a reference value is detected on the x-coordinate, and a certain range around this detected reference value in the x direction is set as a range b of said data acquisition region in the x direction. The calculation unit 220 regenerates, along the y direction, the characteristic quantities of a data acquisition region where the range b is set in the x direction. The distributions of characteristic quantities of a data acquisition region defined by the ranges a and b in the y direction and x direction, respectively, of a fingerprint image obtained along the x and y directions are checked against each other. Thereby, even if there are missing parts in a fingerprint image not only in the vertical direction but also in the horizontal direction, the verification can be done with accuracy.

### Sixth Embodiment

In the first to fifth embodiments, the examples have been described where the image to be verified is an fingerprint image or iris image. In the fifth embodiment, an example was described where when an image is divided along a plurality of directions, the distribution of characteristic quantities obtained along a certain direction is utilized in obtaining the distribution of characteristic quantities along another direction. In a sixth embodiment, examples where an image to be verified is a moving body, such as humans and animals, (hereinafter referred to as “object” where appropriate) will be described based on the fifth embodiment. It is to be noted that a verification method and a verification apparatus described in the sixth embodiment may be described as method and apparatus for identifying an object.

The sixth embodiment relates to a verification apparatus which recognizes a region where an object is positioned, based on two images shot at intervals by an image pickup device, such as a camera, positioned at the ceiling in a room where objects such as people enter and leave. In the sixth embodiment, as one of the two images shot at intervals are regarded as the reference image for the verification and the other thereof is regarded as an object image for the verification. However, it is not necessary to make a clear distinction between these two.

The problems to be solved may be described as follows. In order to recognize the position of an object, a difference between the two images is taken. Since the image data themselves need to be stored in this case, a large memory capacity will be required. Moreover, a heavy processing such as noise rejection needs to be done and therefore the computation amount will be large. On the other hand, desired is a verification method and apparatus, with less memory capacity and less computational amount, which can recognize the position of an object in the light of miniaturization and power saving.

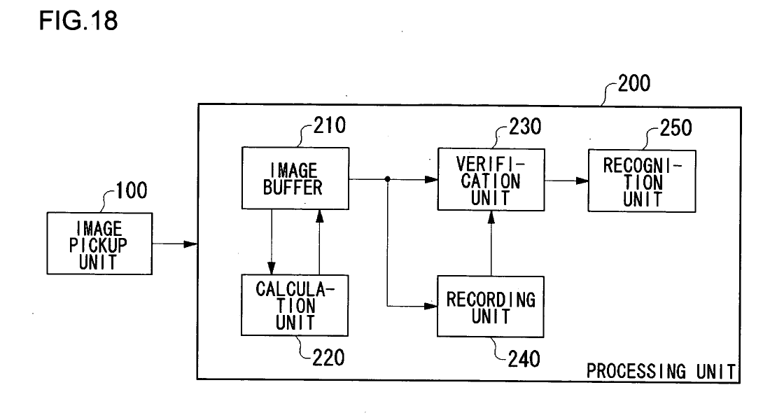

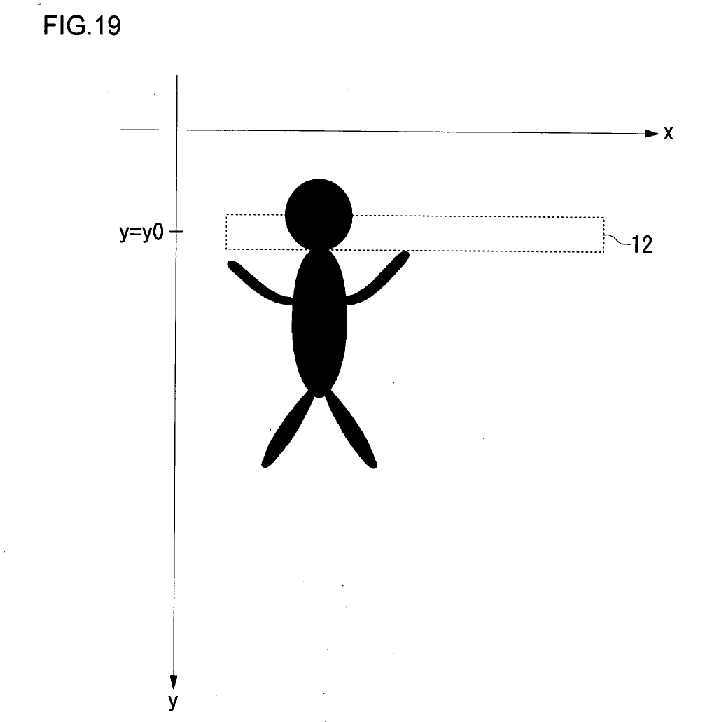

The structure and operation according to the sixth embodiment are basically the same as those of the verification apparatus 1 according to the first embodiment as shown in FIG. 1. Hereinbelow, a description will center around what differs from those of the verification apparatus 1 of the first embodiment. FIG. 18 illustrates a function block of a verification apparatus 1 according to the sixth embodiment. What differs from the structure of FIG. 1 is that the processing unit 200 is comprised additionally of a recognition unit 250. Differing from the first embodiment, a image pickup unit 100 includes a camera installed in, for example, a ceiling or the like of a room where people enter and leave. The image pickup unit 100 continuously picks up the indoor images of a room where an object could be present. Now, examples of images captured by the image pickup unit 100 will be shown. FIG. 19 is the same as FIG. 3 except where the image shot in FIG. 19 is a human. Note that the background or the like other than the human is omitted in FIG. 19. Now refer back to FIG. 18.

An image buffer 210 stores temporarily the image data inputted sequentially from the image pickup unit 100 and also functions as a memory area used as a working area of a calculation unit 220. At the same time, the image buffer 210 stores a distribution of characteristic quantities in the y direction (hereinafter referred to as “distribution of background characteristic quantities”) obtained from an picked-up image of a room where no object exists. The calculation unit 220 computes the distributions of characteristic quantities along the x direction and y direction of image data inputted sequentially to the image buffer 210 from the image pickup unit 100. The calculation unit 220 calculates a difference between the calculated distribution of characteristic quantities in the y direction and the background distribution of characteristic quantities stored in the image buffer 210 and then extracts a distribution of characteristic quantities in the y direction of an object contained in the image data. Hereinafter, this extracted distribution of characteristic quantities in the y direction will be referred to as “extracted distribution of characteristic quantities”. A verification unit 230 compares the extracted distribution of characteristic quantities of image data, to be authenticated, stored in the image buffer 210 and the distribution of characteristic quantities thereof in the x direction (hereinafter referred to as “object distribution of characteristic quantities”) with the extracted distribution of characteristic quantities of image data immediately prior to said image data in terms of time and the distribution of characteristic quantities thereof in the x direction (hereinafter referred to as “reference distribution of characteristic quantities”). The reference distribution of characteristic quantities is stored in a recording unit 240. Differing from the first embodiment, the verification unit 230 compares the object distribution of characteristic quantities with the reference distribution of characteristic quantities so as to derive a difference therebetween.

Since the object distribution of characteristic quantities becomes a reference distribution of characteristic quantities for the next verification at the verification unit 230, the object distribution of characteristic quantities is outputted to a recording unit 240 from the image buffer 210. Suppose that the extracted distributions of characteristic quantities for three image data inputted successively from the image pickup unit 100 are Distribution B1, Distribution B2 and Distribution B3. Then, if the object distribution of characteristic quantities is Distribution B2, the reference distribution of characteristic quantities will be Distribution B1. Similarly, if the object distribution of characteristic quantities is B3, the reference distribution of characteristic quantities will be Distribution will be B2. In this manner, the reference distribution of characteristic quantities stored in the recording unit 240 is updated and thereby rewritten as time advances. The recognition unit 250 recognizes a region where an object is located, based on the thus derived difference.

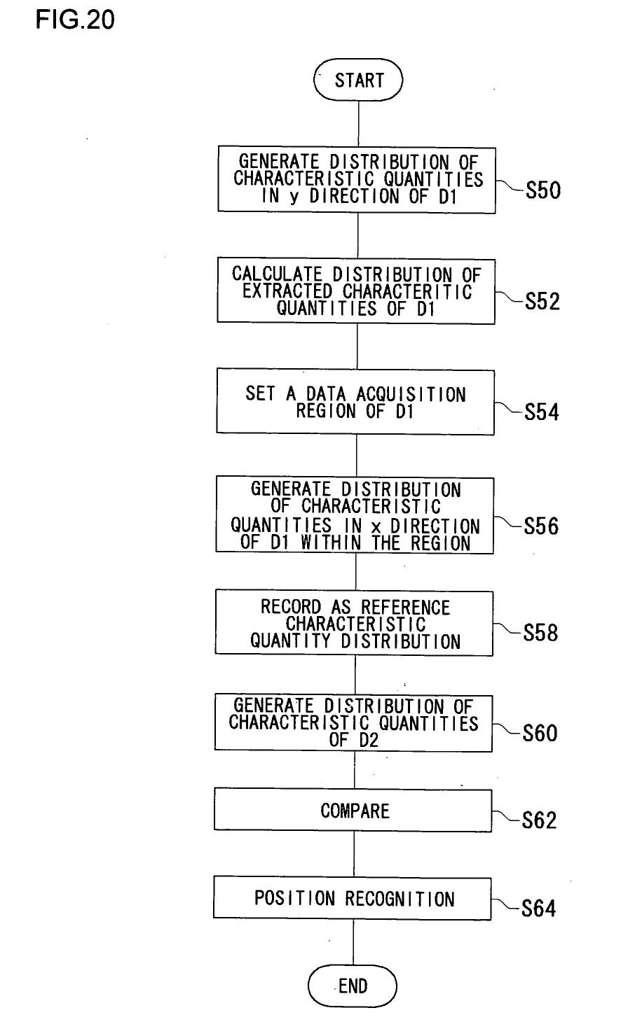

FIG. 20 is a flowchart showing an operation, carried out by the verification apparatus 1, for recognizing a region where an object is located. Described here is a case where the recording unit 240 starts from a state in which it does not hold any reference distribution of characteristic quantities. First, at time t₁, the image pickup unit 100 takes an image of a room in which an object could exist, converts the captured image into electric signals and outputs the electric signals to the processing unit 200. The image data outputted to the processing unit 200 will be referred to as “image data D1” hereinafter. The calculation unit 220 performs the same processings as Step S12 to Step S20 of FIG. 2 on the image data D1 so as to generate a distribution of characteristic quantities in the y direction of the image data D1 (S50). Then the background distribution of characteristic quantities is extracted from the thus generated distribution of characteristic quantities in the y direction so as to calculate the extracted distribution of characteristic quantities of the image data D1 (S52).

The calculation unit 220 performs the processing similar to Steps S42 and S44 shown in FIG. 14 by referring to the extracted distribution of characteristic quantities and then sets a data acquisition region in the y direction of image data D1 (S54). At this time, a range where the extracted distribution of characteristic quantities of image data D1 has values other than 0 or a range containing 50 pixels above and below said range may be set as the data acquisition region. After setting the data acquisition region for the image data D1, a distribution of characteristic quantities within the range is generated along the x direction of the image data D1 by performing the processing similar to Step S45 of FIG. 16 (S56). The distribution of characteristic quantities generated along the x direction within the range will be referred to as “in-region distribution of characteristic quantities” hereinafter. The recording unit 240 records the extracted distribution of characteristic quantities of image data D1 and the in-region distribution of characteristic quantities thereof, as the reference distribution of characteristic quantities (S58).

At time t₂ which comes after t₁, the image pickup unit 100 takes again an image of a room in which an object could exist, converts the captured image into electric signals and outputs the electric signals to the processing unit 200. The image data outputted to the processing unit 200 this time will be referred to as “image data D2” hereinafter. The calculation unit 220 performs the same processings as those carried out to the image data D1 on the image data D2 so as to generate an extracted distribution of characteristic quantities of the image data D2 and an in-region distribution of characteristic quantities thereof (S60). The verification unit 230 compares the reference distribution of characteristic quantities recorded by the recording unit 240 with the object distribution of characteristic quantities stored in the image buffer 210 so as to derive a difference therebetween (S62). In Step S62, the extracted distribution of characteristic quantities of the image data D1 stored in the recording unit 240 in Step S58 and the in-region distribution of characteristic quantities thereof are the reference distributions of characteristic quantities. Also, in Step S62, the extracted distribution of characteristic quantities of the image data D2 generated in Step S60 and the in-region distribution of characteristic quantities thereof are the object distributions of characteristic quantities. That is, since the extracted distribution of characteristic quantities of the image data D2 generated in Step S60 and the in-region distribution of characteristic quantities thereof become the reference distributions of characteristic quantities for the next comparison by the verification unit 230, they are outputted to the recording unit 240 from the image buffer 210.

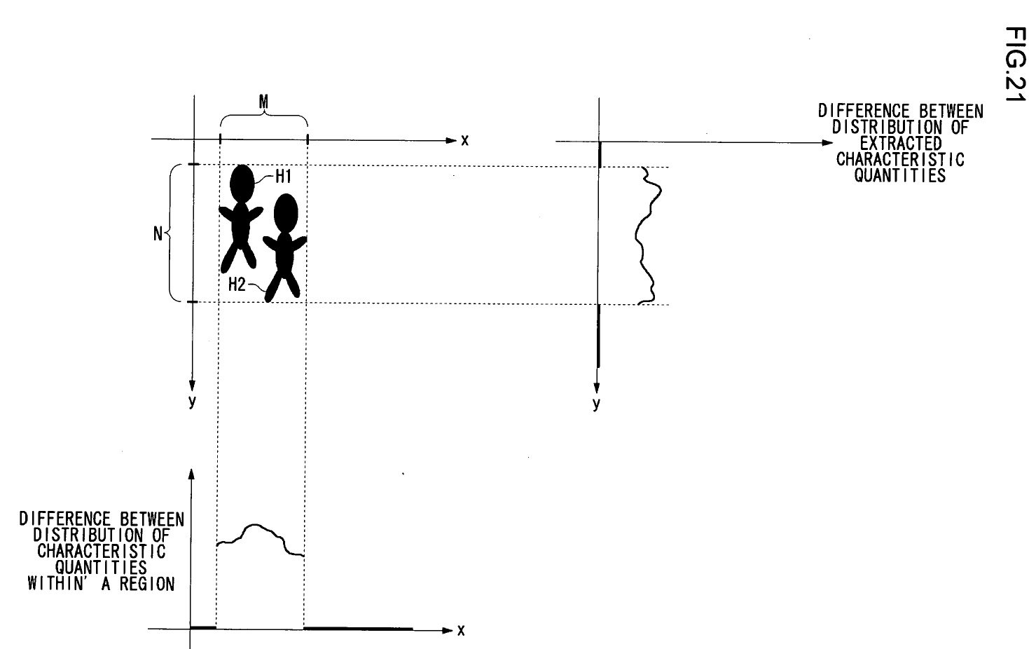

Based on the difference derived by the recognition unit 250, the recognition unit 250 recognizes the region where the object is located (S64). More specifically, the range where the difference in extracted distribution of characteristic quantities between the image data D1 and the image data D2 has values other than 0 is identified as a range where the object is positioned in the y direction. The range where the difference in in-region distribution of characteristic quantities between the image data D1 and the image data D2 has values other than 0 is identified as a range where the object is positioned in the x direction. Then the region determined by the range where the object is located in the y direction and in the x direction is recognized as the region where the object is located. In FIG. 21, the image captured by the image pickup unit 100 of FIG. 18 at time ti and the image captured thereby at time t₂ are superimposed on each other, and a difference in extracted distribution of characteristic quantities between the image data D1 and the image data D2 and a difference in in-region distribution of characteristic quantities therebetween are shown. It is to be noted that the difference in extracted distribution of characteristic quantities and the different in in-region distribution of characteristic quantities each contains x components and y components. However, only either one of them is shown here. A person H1 and a person H2 are the same person but the time when each image of H1 and H2 was taken differs. That is, the image of person H1 was captured at time t₁ whereas the image of person H2 was captured at time t₂.

The differences in the extracted distribution of characteristic quantities have values other than 0, in a range N in the y direction of a position of a person, at time t₁ and time t₂. The difference in the in-region distribution of characteristic quantities have values other than 0, in a range M in the x direction of the position of a person. Thus, the recognition unit 250 recognizes, as a position where a person is located, a region determined by the range N in the y direction and the range M in the x direction. (Hereinafter, the region recognized, as a position where a person is located, by the recognition unit 250 will be referred to as “identified region”). After time t₂, the image pickup unit 100 still sequentially takes images of a room where an object could exist, converts the captured images into electric signals and outputs them to the processing unit 200. The processing unit 200 recognizes the position of an object from the sequentially inputted image data, by performing the above processing.

According to the sixth embodiment as described above, a data acquisition region in the y direction is set to the image data D1 and a distribution of characteristic quantities is generated along the x direction, within the data acquisition region in the y direction thereof. Thus, the increase in computation amount can be prevented in comparison with a case when the distribution of characteristic quantities is generated along the x direction in the entire region. When the distribution of characteristic quantities is generated in the x direction, the effect of noise components in the regions other than the data acquisition region can be reduced. Since the verification method can be applied to recognizing the position of an object in addition to authenticating the fingerprints and irises, the applicability can be extended as the verification method.

### Seventh Embodiment

In the sixth embodiment, the example was described where an image to be verified is a moving body, such as humans and animals, and the regions where those object are located are recognized. A case when the verification method and verification apparatus described in the sixth embodiment are applied to an image processing will be described in a seventh embodiment. It is to be noted that a verification method and a verification apparatus explained in the seventh embodiment may be described as method and apparatus for processing images. The structure and operation according to the seventh embodiment are basically the same as those of the verification apparatus 1 according to the sixth embodiment as shown in FIG. 18. Hereinbelow, a description will center around what differs from those of the verification apparatus 1 of the sixth embodiment.

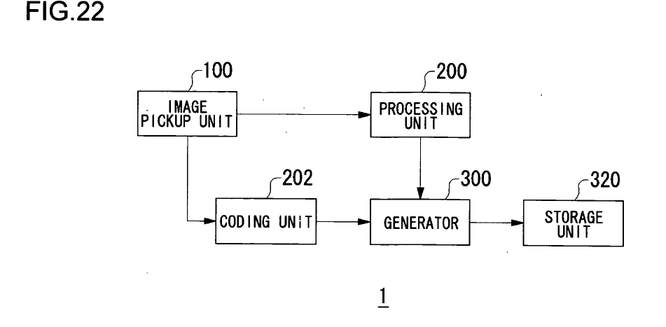

FIG. 22 illustrates a function block of a verification apparatus 1 according to the seventh embodiment. What differs from the structure of FIG. 18 is that the verification apparatus 1 further includes a coding unit 202, a generator 300 and a storage unit 320. The operations of the image pickup unit 100 and the storage unit 320 are the same as those for the sixth embodiment. The coding unit 202 codes the image data, which have been picked up by the image pickup unit 100 and then converted into electric signals, by using a coding method complying with the MPEG (Moving Picture Expert Group) standard. The generator 300 generates streams that contain the image data coded by the coding unit 202 and the positional data on the aforementioned identified region recognized by the processing unit 200. The generator 300 may also generated streams that further contain the data on the extracted distribution of characteristic quantities and in-region distribution of characteristic quantities of the image data generated by the processing unit 200. Alternatively, the data on the aforementioned extracted distribution of characteristic quantities and in-region distribution of characteristic quantities may be contained in place of the positional data.

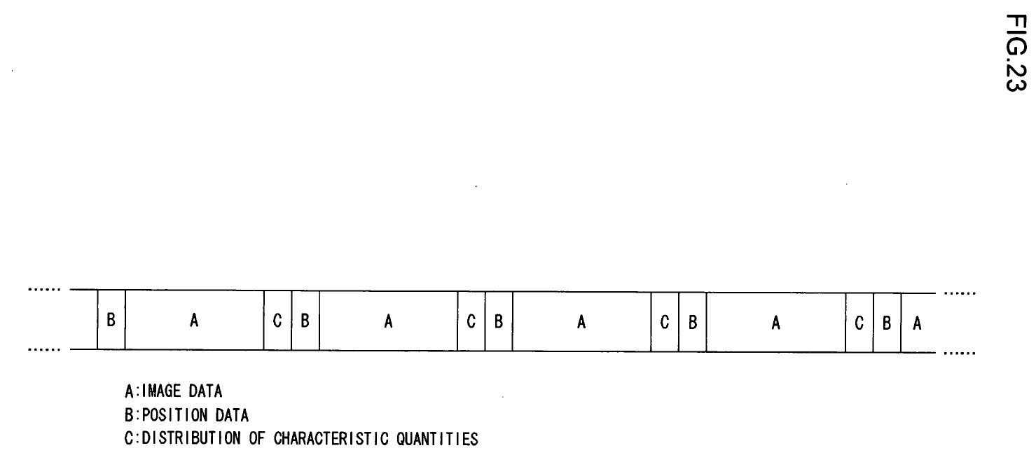

FIG. 23 illustrates an arrangement of streams generated by the generator of FIG. 22. Referring to FIG. 23, A indicates a coded image data. A group of image data A contains data on a plurality of images captured at time intervals. B indicates positional data on an identified region that the processing unit 200 has recognized among the data on a plurality of images. For instance, if the group of image data A is data on two images superimposed as shown in FIG. 21, the identified image will be identified by the range N in the y direction and the range M in the x direction of FIG. 21. Thus, it is preferable that the positional data B contain the coordinates to indicate the region. C is data on the extracted distribution of characteristic quantities and in-region distribution of characteristic quantities generated by the processing unit 200. The generator 300 may, for example, insert known signals, respectively, into between an extracted distribution of characteristic quantities and an in-region distribution of characteristic quantities, so as to indicate a boundary for each data.

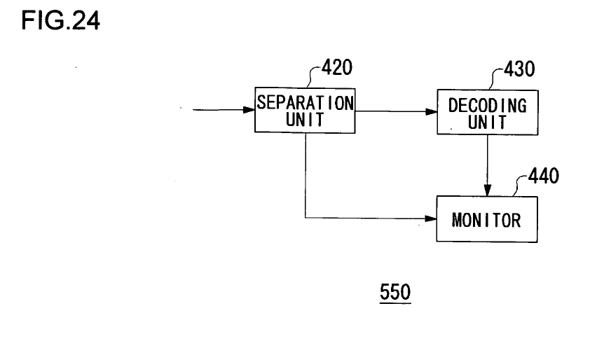

FIG. 24 illustrates a structure of a reproducing apparatus 550 which reproduces and displays the streams shown in FIG. 23. The reproducing apparatus 550 includes a separation unit 420, a decoding unit 430 and a monitor 440. The streams shown in FIG. 23 are inputted to the separation unit 420. The separation unit 420 separates the inputted streams into image data, positional data and data on the distribution of characteristic quantities. As described above, if the known signals are inserted into among the image data, the positional data and the data on the distribution of characteristic quantities and in-region distribution of characteristic quantities, respectively, the streams can be separated based on the known signals. The decoding unit 430 decodes the thus separated image data, using a decoding method corresponding to the coding method. The monitor 440 displays an image obtained from the decoded image data and a region identified by the positional data in a manner such that they are superimposed on each other and the respective coordinates are associated with each other.

According to the seventh embodiment as described above, the advantageous effects similar to the sixth embodiment are obtained. Furthermore, according to the seventh embodiment, the generator 300 generates streams that contain the coded image data and positional data on a region in which the object is located, so that the reproducing apparatus 550 can easily extract the object within the image, from the streams generated. Since the trajectory of movements or appearance scenes of an object can be searched at high speed, any suspicious person can be easily searched out from a huge amount of monitored images if an image processing apparatus 500 is applied to a surveillance camera or the like, for example.

### Eighth Embodiment

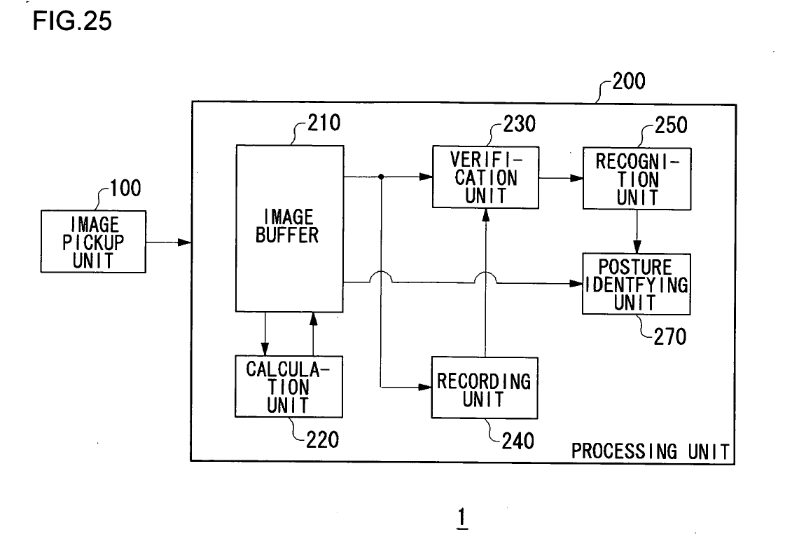

In the sixth embodiment, an example was described where images to be verified are moving bodies such as humans and animals and a region in which such an object is located is recognized. In an eighth embodiment, a case where not only the position of an object but also the posture thereof will be recognized. The structure and operation of a verification apparatus 1 according to the eighth embodiment are basically the same those of the verification apparatus 1 according to the sixth embodiment as shown in FIG. 18. Hereinbelow, a description will center around what differs from those thereof. FIG. 25 illustrates a function block of a verification apparatus 1 according to the eighth embodiment. What differs from the structure of FIG. 18 is that the processing unit 200 is comprised additionally of a posture identifying unit 270. The posture identifying unit 270 acquires pixel values of the identified region recognized by the recognition unit 250, from the image buffer 210 and then identifies a distance between a camera and an object. Next, as will be described later, the posture will be identified.

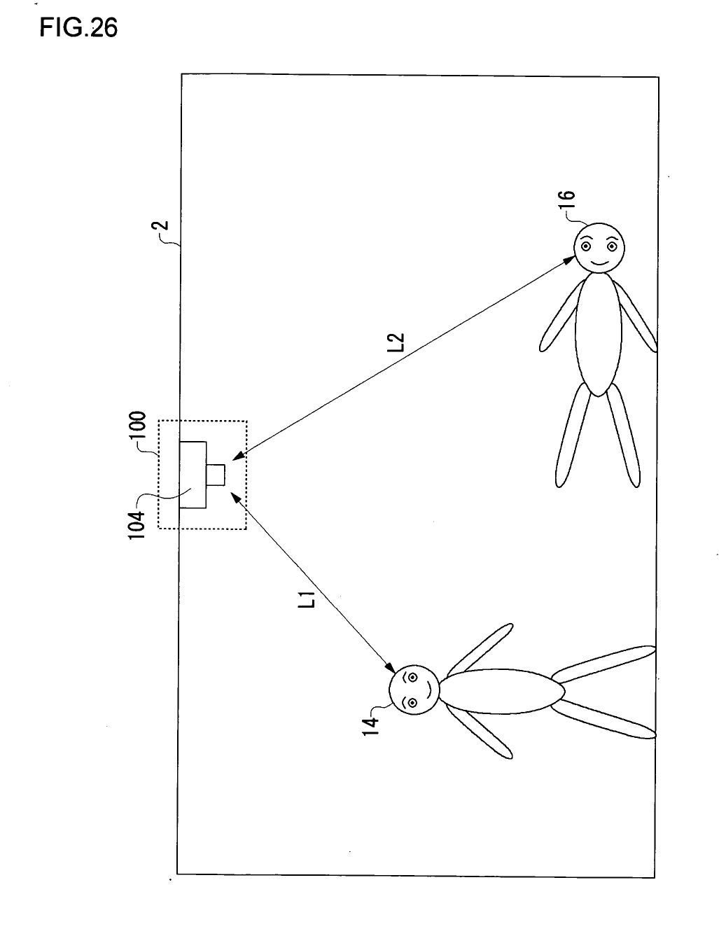

FIG. 26 illustrates a method by which a posture identifying unit 270 identifies the posture of an object. A camera 104 included in an image pickup unit 100 is placed at the ceiling of a room 2. L1 represents a distance between a camera 104 and an object 14 whereas L2 a distance between the camera 104 and an object 16. Note that the camera 104 alone is shown in FIG. 26 and the other parts of the verification apparatus 1 are omitted. For example, if an identified distance is “farther” or “nearer” than the pixel value in a region, where an object is located, by comparison with a threshold value Lz, the posture identifying unit 270 identifies it to be a “sleeping” posture or “uprising” posture, respectively. The threshold value Lz is determined as appropriate according to the height or the like at which the camera 104 is placed. More specifically, if L1<Lz<L2, the distance L1 from the camera 104 to the object 14 in FIG. 26 is nearer compared with the threshold value Lz. Thus, it is determined that the object 14 is standing up. As for the object 16, since the distance from the camera 104 to the object 16 is farther compared with the threshold value Lz, it is determined that the object 16 is sleeping.

According to the eighth embodiment as described above, the advantageous effects similar to the sixth embodiment are obtained. Furthermore, according to the eighth embodiment, the images containing information on distances are used, so that the posture of an object in addition to the position thereof can be identified based on the distance information as well as the positional information on objects. Hence, the applicability of an verification apparatus 1 is extended. Furthermore, a distance sensor (not shown) may be provided separately from the camera 104, so that the posture identifying unit 270 may identify the distance between the camera 104 and an object, based on the distance information acquired by the distance sensor. In such a case, the posture of the object in addition to the position thereof can be identified even when the camera 104 takes normal images.

### Ninth Embodiment

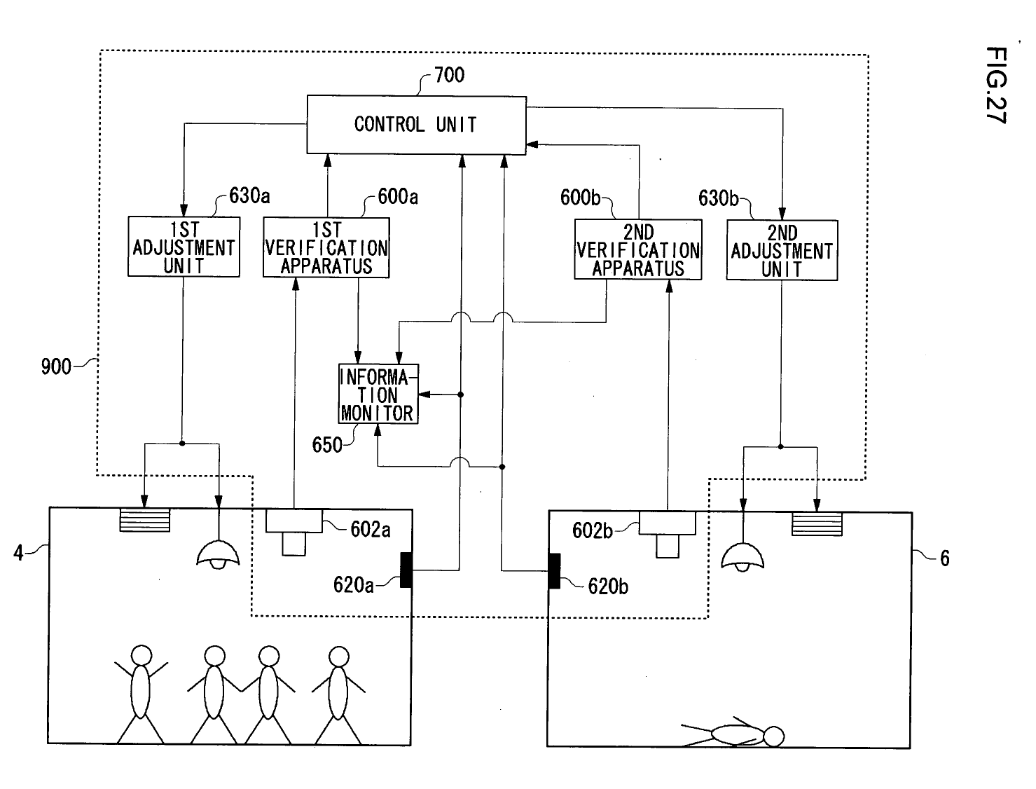

In the eighth embodiment, a case was explained where not only the position of an object but also the posture thereof is recognized. In a ninth embodiment, a case where an environment of a room in which an object is present is controlled based on the posture of the object recognized. FIG. 27 is a function block of an environment controlling apparatus 900 according to the ninth embodiment. The environment controlling apparatus 900 includes a first verification apparatus 600a, a second verification apparatus 600b, a first camera 602a, a second camera 602b, a first acquisition unit 620a, a second acquisition unit 620b, a first adjustment unit 630a, a second adjustment unit 630b, an information monitor 650 and a control unit 700. The first verification apparatus 600a and the second verification apparatus 600b have the same structure as that of the verification apparatus 1 shown in FIG. 25 and therefore the repeated description therefor is omitted here. For the clarity of explanation, the first camera 602a and the second camera 602b are described separately from the first verification apparatus 600a and second verification apparatus 600b.

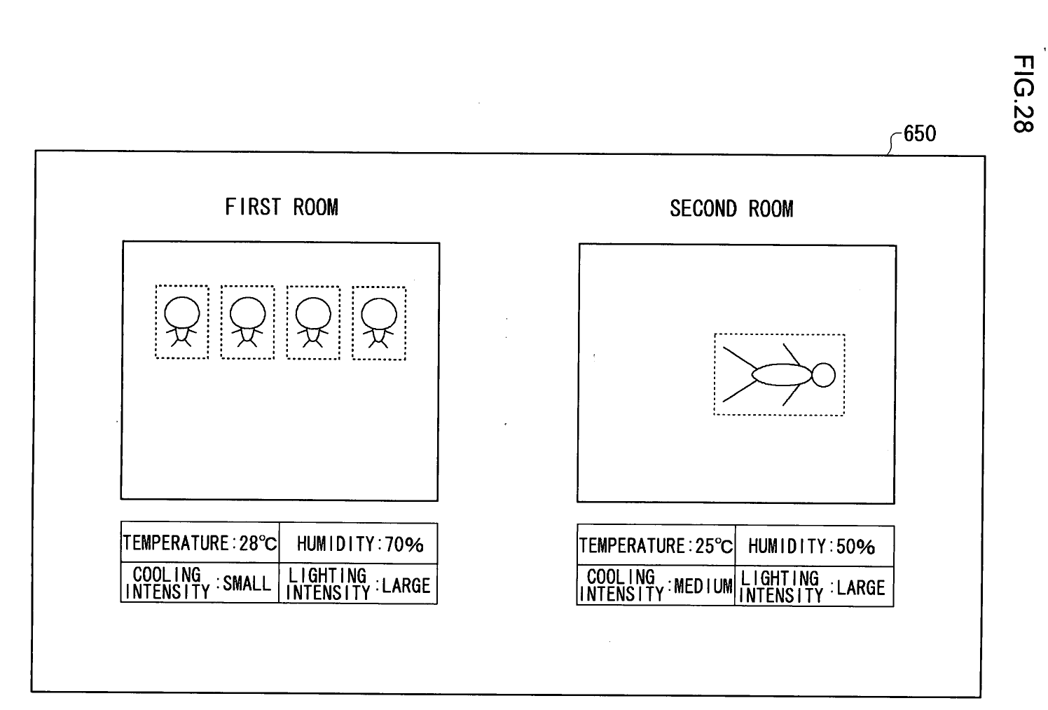

The first verification apparatus 600a recognizes the position and posture of an object or objects in a first room 4. The second verification apparatus 600b recognizes the position and posture of a person in a second room 6. The first acquisition unit 620a acquires information on environment in the first room 4. The second acquisition unit 620b acquires information on environment in the second room 6. The first acquisition unit 620a and second acquisition unit 620b may be comprised, for example, of a temperature sensor and/or humidity sensor and so forth. The environment information may be the temperature, humidity, illumination intensity, the working situation of home appliances or other information. The first adjustment unit 630a adjusts the environment of the first room 4. The second adjustment unit 630b adjusts the environment of the second room 6. The information monitor 650 displays simultaneously the information on the positions, postures and environments in the first room 4 and second room 6 obtained by the first verification apparatus 600, the first acquisition unit 620a, the second verification apparatus 600b and the second acquisition unit 620b, respectively. FIG. 28 illustrates an example of display by the information monitor 650 of FIG. 27. The information monitor 650 displays images, positions of objects, temperatures, humidities, cooling intensities and illumination intensities of the first room 4 and the second room 6, respectively. Now refer back to FIG. 27.

The control unit 700 controls the operations of the first adjustment unit 630a and the second adjustment unit 630b, based on the positions and postures of the objects recognized by the first verification apparatus 600a and second verification apparatus 600b and the environment information acquired by the first acquisition unit 620a and second acquisition unit 620b. For example, when the object is sleeping in the second room 6 and the light is on, the control unit 700 may control the second adjustment unit 630b so that the light can be put out. As shown in FIG. 28, when many objects are present in the first room 6 and a single object is present in the second room 6, the control unit 700 controls the first adjustment unit 630a and the second adjustment unit 630b so that, for example, the cooling intensity of the first room 4 becomes larger than that of the second room 6. The number of objects can be known from the number of positions recognized.

The ninth embodiment as described above provides the same advantageous effects as those of the eighth embodiment. Furthermore, according to the ninth embodiment, the environments of the respective locations are controlled using relative information on two different places, so that the environment can be controlled with a high degree of accuracy than when a single location is controlled independently.

### Tenth Embodiment

In the second embodiment, an example of methods for dividing in a plurality of directions was explained. That is, a plurality of characteristics obtained after dividing an image into a plurality of directions are compared between the corresponding characteristics in reference to the reference image and the image to be authenticated, whereby the highly accurate verification is carried out. In this regard, it is assumed in a tenth embodiment that when a plurality of images are compared, the number of characteristics acquired in one or more directions per image differs. Then the characteristics are compared to one another in various combinations among images so as to compensate for the rotation error or rotation displacement.

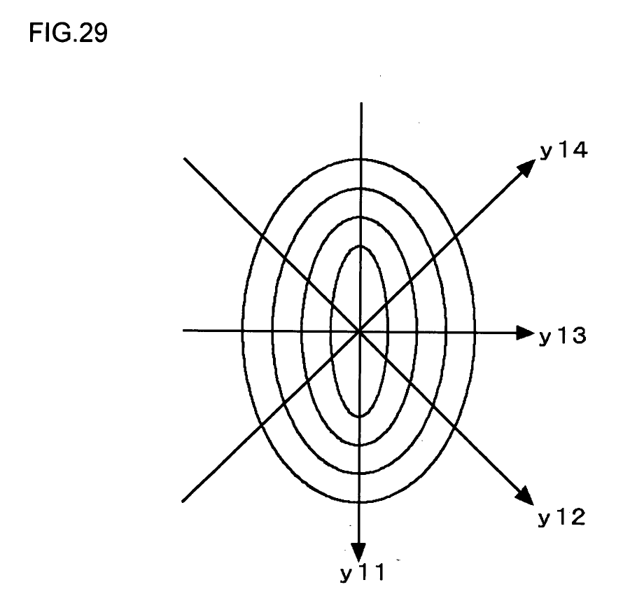

Assume first that either one of the reference image and the image to be authenticated has a plurality of extracted characteristics in a plurality of directions whereas the other has a characteristic in a single direction. Here, the characteristic or feature may be obtained as a function of coordinate axes that indicate a direction or directions serving as a reference used to obtain the characteristic, or it may be a distribution of characteristic quantities calculated, as described above, based on the gradient vectors. FIG. 29 illustrates an example according to the tenth embodiment where the characteristics are extracted in a plurality of directions. The characteristics are extracted in a plurality of directions having different angles, respectively. Four directions only are shown in FIG. 29, for the sake of convenience. More specifically, four coordinate axes y11 to y 14 only are shown in FIG. 29. In this regard, the coordinate axes may be provided in an increased plurality of directions and thus the angles formed by adjacent coordinate axes may be set smaller. The more the directions along which the characteristics are extracted, the more accurately the rotation displacement at the time of image verification can be detected and compensated for.

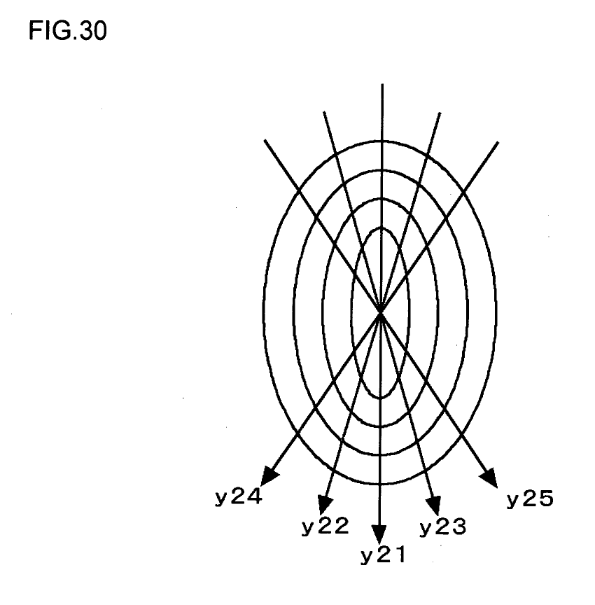

FIG. 30 illustrates a modification to the tenth embodiment where the characteristics are extracted in a plurality of directions. When the characteristics are calculated in a plurality of directions of an image, the range of angle by which to set the directions is restricted. Referring to FIG. 30, when a plurality of coordinate axes y21 to y24 having different angels, respectively, are set on an image, the coordinate axes having narrower angles with respect to the vertical axis are set and no wide-angle coordinate axes are set. This setting of the directions on an image is done in a manner that associates it with a physical mode of an image pickup unit 100 capturing said image.

For example, if a user is asked to slide his/her finger from the upper position to the lower position or from the lower position toward the upper position to take a fingerprint image, the range of displacement of the finger will be regulated by providing a guide portion that guides and controls the sliding movement of a finger. When the directions are set on the image in association with this regulating scheme, the extraction of characteristics of no use to detect the rotation displacement in a direction normally impossible can be eliminated. On the contrary, if the rotation displacement may well be caused in the capturing of an fingerprint image or the like by a surface sensor or the like, it is preferred that the characteristics be extracted in all directions as shown in FIG. 30.

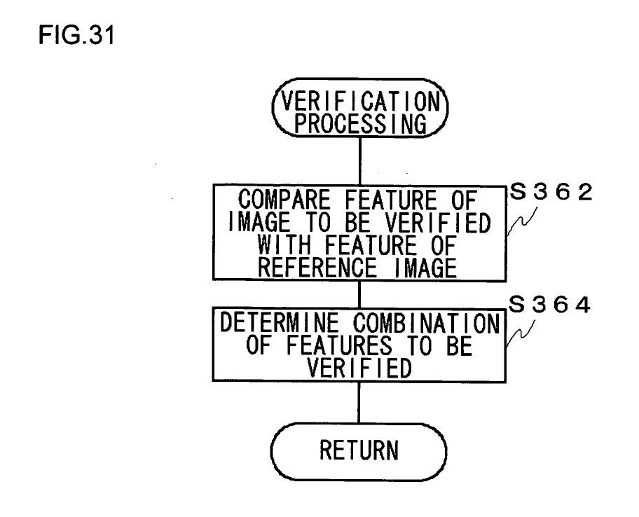

Hereinbelow, the tenth embodiment will be described in detail based on the above assumption. The structure and operation according to the tenth embodiment are basically the same as those of the verification apparatus 1 according to the first embodiment as shown in FIG. 1. Hereinbelow, a description will be given of what differs from those of the verification apparatus 1 of the first embodiment. FIG. 31 is a flowchart to explain a processing, according to the tenth embodiment, for verifying a plurality of images. It is assumed herein that the flowchart shown in FIG. 31 is equivalent to a subroutine for the verification processing (S34) in the flowchart of FIG. 6.

First, an example will be explained where either an reference image or an image to be authenticated has characteristics in a plurality of directions as shown in FIG. 9 or FIG. 30 and the other image has characteristics in a single direction. More specifically, a case where the reference image has characteristics in a plurality of directions and the image to be authenticated has characteristics in a single direction will be explained here.

Referring to FIG. 31, the calculation unit 220 sequentially compares the characteristics calculated for a predetermined direction of an image to be authenticated, with the respective characteristic calculated for a plurality of directions of a reference image (S362). Here, it is not necessary to do the pattern matching, for each comparison, on the same axis explained in the flowchart of FIG. 6. It suffices if the characteristics of the above reference image that approximates most closely the characteristics of the above image to be authenticated can be identified. And for each characteristic, the summation of characteristic quantity that constitutes it may be calculated and those characteristics may be compared one another. The order in which they are compared may be arbitrary and various kinds of algorithms may be used. For example, a comparison object may be gradually moved in the right and left direction alternately from a direction having an angle closer to the horizontal direction toward a direction having an angle closer to the vertical direction The calculation unit 220 determines combination of the characteristic of the above image to be authenticated and that of the reference image that approximates most closely said characteristic thereof (S364). As described in the flowchart of FIG. 6, those characteristics are then compared and checked in further detail, and whether they are to be authenticated or not is determined. The comparison of the characteristic of the image to be authenticated with the respective characteristics of the above reference image may be processed as shown in FIG. 6. When verification results on the degree of matching with which the authentication is granted are obtained, the authentication may be granted at that stage.

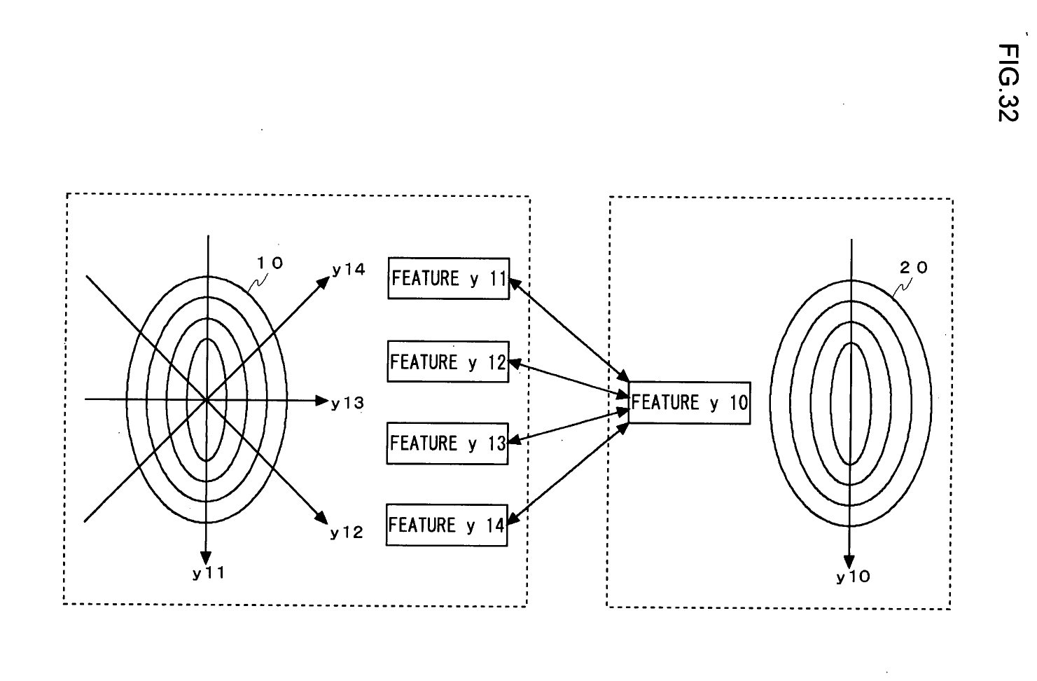

FIG. 32 explains an example in the tenth embodiment where one image of an object to be verified has characteristics in a plurality of directions whereas the other image of the object has characteristics in a single direction. Referring to FIG. 32, the coordinate axes y11 to y14 are set on one fingerprint image in a plurality of directions. The calculation unit 220 calculates characteristics along the respective coordinate axes. A feature y11, namely, a characteristic quantity y11, shown in FIG. 32 indicates a characteristic quantity for the corresponding coordinate axis y11. The coordinate axis y10 is set on the other fingerprint image in the vertical direction. In this case, a feature y10, namely, a characteristic quantity y10, for this coordinate axis y10 and the respective features y11 to y14 of the former fingerprint image 10 are compared and verified. Therefore, the comparison and verification are done four times in FIG. 32.

Accordingly, when the feature of a reference image is set to a plurality of characteristics and the feature of an image to be authenticated is set to a single characteristic, the time necessary for extracting the characteristic of the image to be authenticated does not increase at the time of verification. Hence, the verification accuracy can be improved while the increase in verification time is being restricted. On the other hand, when the characteristic of a reference image is set to a single characteristic and the characteristic of an image to be authenticated is set to a plurality of characteristics, the verification accuracy can be enhanced while the amount of data to be recorded as reference data is being restricted. The verification method as shown in FIG. 32 can be not only exercised on the comparison and verification between two images but also applied to the comparison and verification among three or more images. It suffices if at least one of them has a characteristic in a single direction.

Next, an example will be described where both the reference image and the image to be authenticated have characteristics in a plurality of directions as shown in FIG. 29 or FIG. 30. A relative angle in between a reference image and an image to be authenticated is varied so as to perform verification a plurality of times. For example, the both images are not tilted at all, either one of images is tilted by a small amount, or the tilted one is further inclined. In this manner, the images are compared and verified while neither images are rotated or one image is rotated.

Referring to FIG. 31, the calculation unit 220 compares sequentially a first group of characteristics that includes characteristics extracted in a plurality of directions of an image to be authenticated with a second group of characteristics that includes those extracted in a plurality of directions of a reference image enrolled in the recording unit 240 while the composition pattern of each characteristic that constitutes either the first or second group is varied (S362). Among a group of characteristics where the composition pattern is fixed and a group of characteristics where the composition pattern has been varied, the calculation unit 220 determines a combination with a group of characteristics that approximates most closely to the group of characteristics where the composition pattern is fixed (S364). Then, as have been explained in the flowchart of FIG. 6, the respective characteristics of the group of characteristics are verified in detail, and whether or not to execute authentication is decided. In this case, the verification accuracy can be improved by verifying and checking the characteristics along a plurality of directions as discussed in the second embodiment.

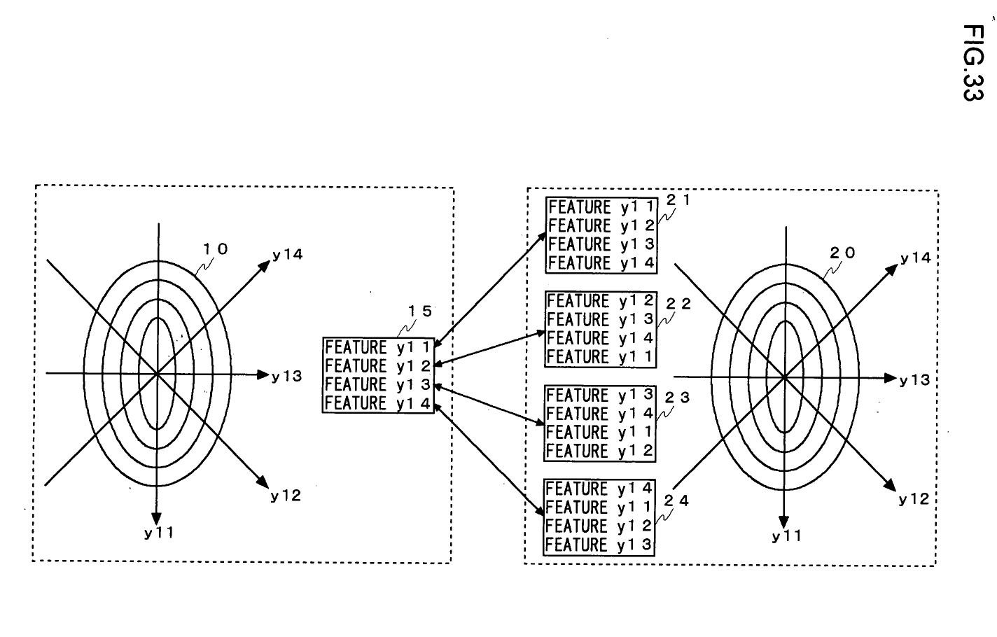

FIG. 33 explains an example in the tenth embodiment where a plurality of images to be verified have characteristics in a plurality of directions. Referring to FIG. 33, the coordinate axes y11 to y14 are set on one fingerprint image in a plurality of directions. The coordinate axes y11 to y14 are set on the other fingerprint in a plurality of directions. The calculation unit 220 calculates characteristics along the respective coordinate axes. For the former fingerprint image 10, the thus calculated respective characteristics or features y11 to y14 are put together so as to set up a group of characteristics 15. For the latter fingerprint image 20, too, the thus calculated respective characteristics or features y11 to y14 are put together so as to set up a group of characteristics. Then the composition pattern of this group of characteristics is varied. Alternatively, a plurality of groups of characteristics 21 to 24 whose composition patterns differ from one another may be formed beforehand and then used in turn. Four kinds of groups of characteristics 21 to 24 are formed in an example shown in FIG. 33. Each of the groups of characteristics 21 to 24 and the group of characteristics 15 are compared and verified.

In particular, the respective characteristics y11 to y14 that constitute the group of characteristics 15 for the former fingerprint image 10 and the respective characteristics y11 to y14 that constitute a certain group of characteristics 21 for the latter corresponding thereto are compared and verified. Next, while the former is being fixed, the respective characteristics y11 to y14 that constitute the group of characteristics 22 whose composition pattern differs from the above group of characteristics 21 are compared with and verified against the characteristics y11 to y14 of the former corresponding thereto. In the similar manner, they are compared and verified with the other groups of characteristics whose composition patterns differ. This method is equivalent to comparing and verifying the both images 10 and 20 by changing the characteristics that are corresponded to. Thus, a simulation circumstance can be created where the fingerprint image 20 of the latter is compared and verified with the fingerprint image 10 of the former while the fingerprint image 20 of the latter is being rotated. In this manner, features are extracted for a plurality of directions of both a reference image and an image to be authenticated, and then are compared and verified while a state in which either one of them is rotated is being simulated, so that the rotation error or rotation displacement can be detected with accuracy. Hence, the verification accuracy can be improved.

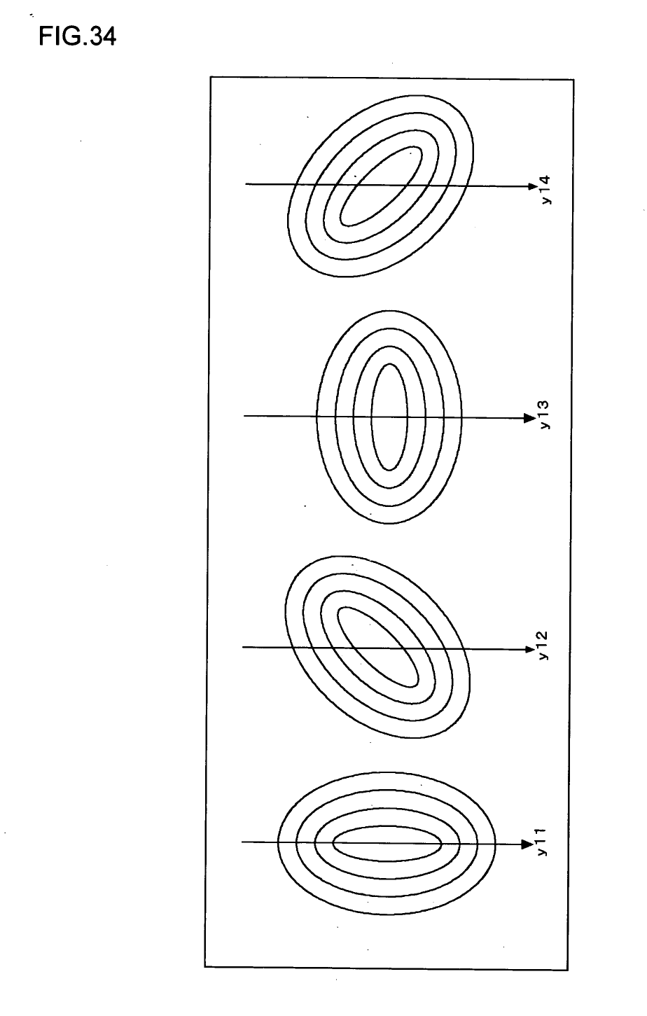

Next, a specific method by which to extract characteristics of an image, as shown in FIG. 29 or FIG. 30, in a plurality of directions will be explained. FIG. 34 illustrates an example in which the characteristics are extracted in a plurality of directions by rotating an image. The calculation unit 220 extracts the characteristics of image data, in a predetermined direction, which was inputted from the image pickup unit 100 and stored temporarily in the image buffer 210. Next, this image data is rotated by a predetermined angle and then the characteristics are extracted in a predetermined direction of said image data. The characteristics for a plurality of directions of an image can be extracted by repeating this procedure. Referring to FIG. 34, the image data is rotated clockwise by a predetermined angle each time and then the characteristics are extracted, for each state, in the vertical direction of image data.

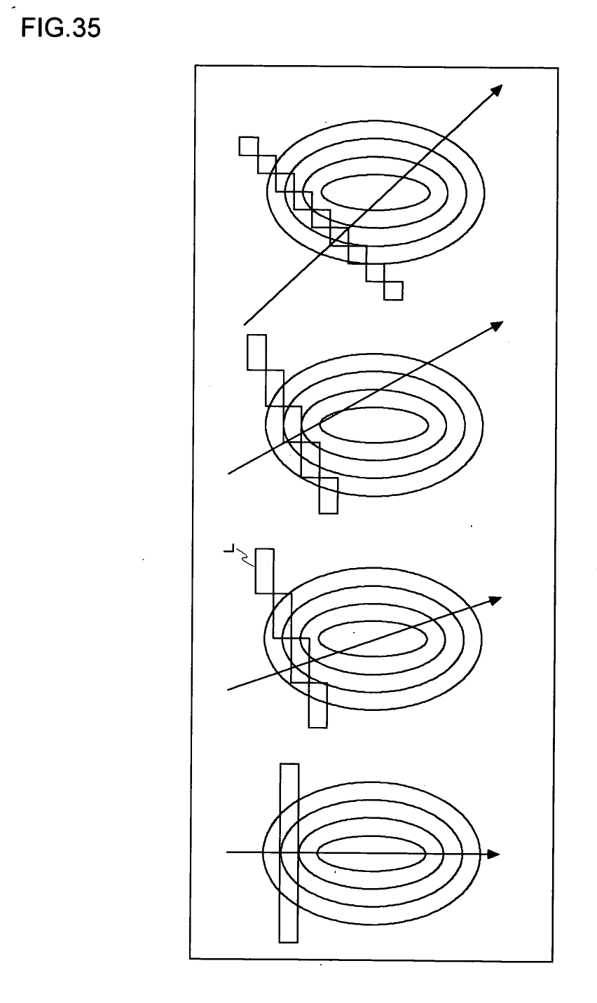

Next, another method for extracting the characteristics of an image along a plurality of directions will be explained. FIG. 35 illustrates an example in which the characteristics for a plurality of directions are extracted without rotating the image. For the vertical direction or horizontal direction, a linear region can be easily set and decided so as to extract the characteristics thereof. Referring to FIG. 35, a method will be explained where the characteristics are extracted in an oblique direction without rotating the image. When the characteristics are to be extracted in an oblique direction, the calculation unit 220 first needs to set a linear region vertical to the oblique direction. This linear region is simulated by combining a plurality of predetermined square or rectangular regions L formed along the vertical and horizontal axes of an image. As described above, in a case where the characteristic quantity is calculated using the gradient vector of each pixel, the processing which will be explained in the following is possible if square regions composed of at least nine pixels are set in a matrix.

The calculation 220 rotates the characteristic quantity of each square region L in accordance with an angle formed between a direction, for obtaining the characteristics, set in an image and the vertical or horizontal direction. This makes it possible to do the calculation in the vertical direction against a direction for practically obtaining the characteristics. Then the characteristic quantities of the respective square region L are added up about the square regions L that simulate the same linear region. For example, when the gradient vectors are utilized, each pixel vector in each square region L is calculated and said vector is rotated in accordance with the above angle. The thus obtained gradient vectors are summed up for square regions to simulate the same linear region. In this case, the rotation amounts of gradient vectors may be provided beforehand in the form of a table in the recording unit 240, for each angle to be compensated for.

By performing a processing like this, the characteristics for a plurality of directions can be extracted without the trouble of rotating an image. In other words, the state equivalent to when the image is rotated can be simulated. Since there is no need to rotate the image data, the memory area otherwise necessary therefor is not required, thus not placing any burden on a system.

According to the tenth embodiment as described above, the verification of images can be performed highly accurately with less memory capacity and less calculation amount. For example, if the direction of a finger differs even in the identification of the same person between when the reference data is enrolled and when it is requested and therefore a rotation is caused in between the two images, the authentication is likely to fail. In this regard, according to the tenth embodiment this rotation displacement is corrected and the image whose rotation has been corrected is verified against the other, so that the authentication can be determined successful if the fingerprint belongs to the same person.

### Eleventh Embodiment

In the above embodiments, the distributions of characteristic quantities shown in FIG. 5 are compared each other. It is assumed in an eleventh embodiment that the image pickup unit 100 is constituted by a line sensor or the like. An example will be explained where an entire image is produced from a plurality of partial images captured by the line sensor with a simple processing performed.

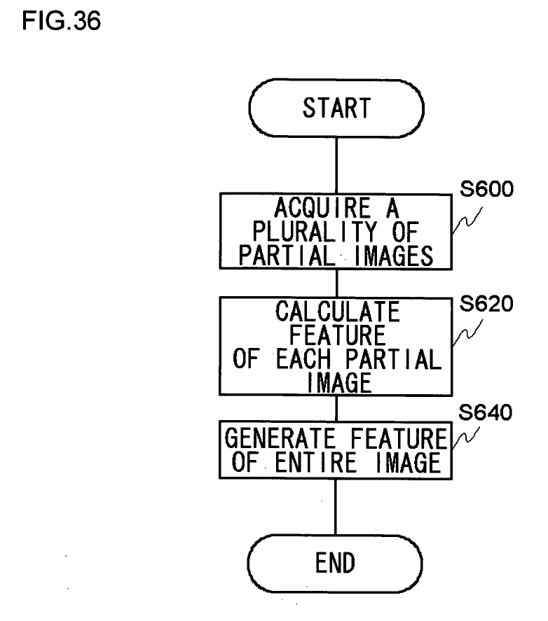

FIG. 36 is a flowchart explaining an image acquiring processing according to an eleventh embodiment. It is first assumed in the eleventh embodiment that an image pickup unit 100 is not provided with a surface sensor or the like capable of acquiring an image of an object, e.g. a finger, to be captured as an entire image by one-time image taking. Thus, a user is asked to move his/her object to be image-taken. The verification apparatus 1 acquires a plurality of partial images by taking an image of the object a plurality of times with a sensor whose image pickup area is small. For example, when a fingerprint image is acquired by a line sensor, a user is asked to slide his/her finger against the line sensor from the upper position to the lower position or from the lower position toward the upper position so as to acquire a plurality of partial images of the fingerprint image.

As described above, referring to FIG. 36, the verification apparatus 1 acquires from the image pickup unit 100 a plurality of partial images of an object to be captured, and stores the thus acquired partial images in the image buffer 210 (S600). The calculation unit 220 calculates characteristics for the respective partial images (S620). Here, the characteristics or features may be obtained as a function of coordinate axes that indicate the directions serving as references to obtain them. Alternatively, they may be the aforementioned distributions of characteristic quantities calculated based on the gradient vectors. The characteristics of adjacent partial images are joined together so as to generate a characteristic of an entire image (S640). Then, as explained in the above embodiments, the characteristics of the entire images are compared and verified each other so as to perform user authentication.

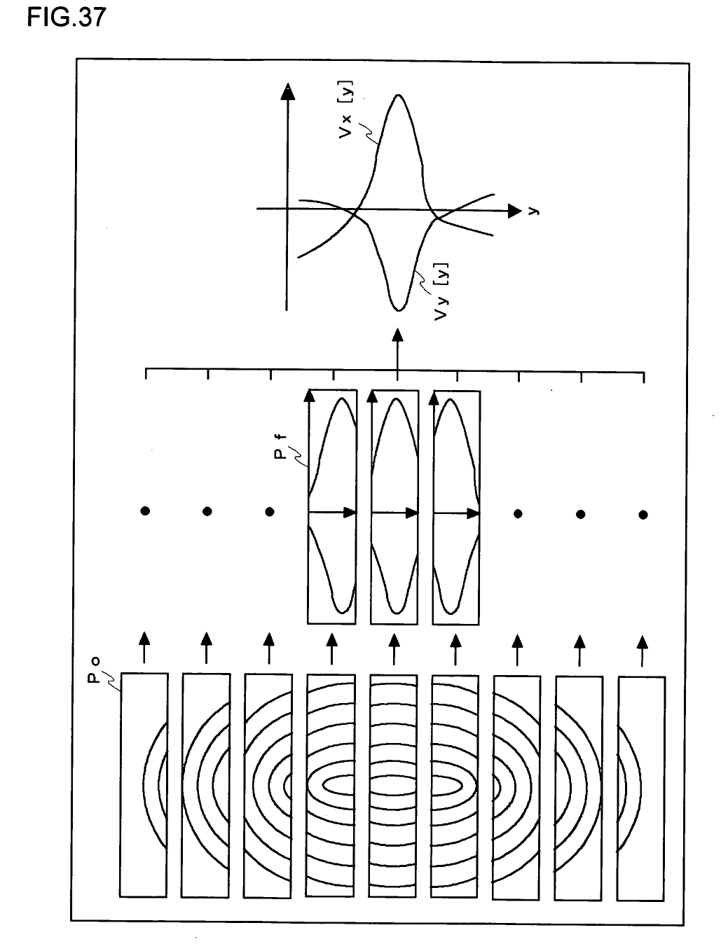

FIG. 37 illustrates a process according to the eleventh embodiment where the characteristics of an entire image is produced from the partial images. FIG. 37 shows a plurality of partial images Po acquired when a user is asked to slide his/her finger against a line sensor, provided horizontally, from the upper position to the lower position or from the lower position to the lower position. Each partial image Po is set approximately to a region of 6 to 8×100 to 200 pixels, which corresponds to the image pickup area of the line sensor. When the verification apparatus 1 is applied to a portable terminal or the like, a space provided for mounting the image pickup unit 100 is limited and therefore there will be many cases where a sensor having such a small image pickup area needs to be used. The image pickup unit 100 take images at the assumed finger sliding speed with such timing that the upper half and the lower half of the partial images Po overlap each other.

The calculation unit 220 calculates a characteristic quantity Pf for each partial image Po. Then the characteristics Pf of the successive partial images Po are connected together. Since the finger sliding speed may vary every time a different user places his/her finger on the sensor, a connection condition as to how appropriately the adjacent partial images overlap among the partial images Po needs to be detected. There is a case where no images overlap and therefore the adjacent partial images Po are pieced together as they are. In the case of FIG. 37, as a method for superimposing the characteristics of the respective partial images Po, the x component and the y component of gradient vectors are superimposed among the adjacent partial images Po. By implementing this scheme, how many pixels have been slid among the adjacent partial images Po can be detected and this is each done between the two adjacent partial images Po so as to generate the characteristic of an entire fingerprint image.

If the sliding of a finger is stopped, the same partial images will be acquired. In such a case, the calculation unit 220 may eliminate any of the adjacent partial images. Also, at least one of a partial image near the upper end and a partial image near the lower end may be ignored and partial images near the center may mainly be produced as the reference data or the data to be authenticated. When a user slides his/her finger very fast, the image pickup unit 100 cannot pick up part of the entire image and the characteristic quantities of the entire image cannot be constructed. Thus, an error processing in which the user is asked to enter the input of an image again may be performed.

According to the eleventh embodiment, the characteristics of an entire image are produced from a plurality of partial images. In this regard, connection conditions may be obtained by comparing and verifying the respective characteristics Pf of adjacent partial images Po and then an entire image may be restructured or reconstructed from a plurality of partial images Po by utilizing the connection conditions. Then, by use of this entire image, the identification can be executed by not only the authentication method for comparing and verifying the characteristics described in the aforementioned embodiments but also the aforementioned minutiae method, pattern matching method, chip matching method and frequency analysis method.

According to the eleventh embodiment as described above, when an entire image is obtained from partial images of an image to be picked up, the characteristics of the respective partial images are extracted so as to obtain the characteristics of the entire image by using those extracted from the partial images. As a result, the memory capacity can be reduced. In other words, although the method is generally implemented where an entire image is reconstructed by comparing and verifying the partial images of one another, the characteristics of the partial images are compared and verified one another in the eleventh embodiment. Hence, a memory area necessary for comparing and verifying the partial images per se is not required in the eleventh embodiment, thus not placing the burden on a system. As a result, the eleventh embodiment can be applied to a system with relatively low specifications. This advantageous effect is generally applicable when an entire image itself is reconstructed from a plurality of partial images.

### Twelfth Embodiment

In the eleventh embodiment, an example was explained where an entire image is generated from a plurality of partial images. According to a twelfth embodiment, the reconstruction of an entire image is not even required. Such a verification method will now be explained.

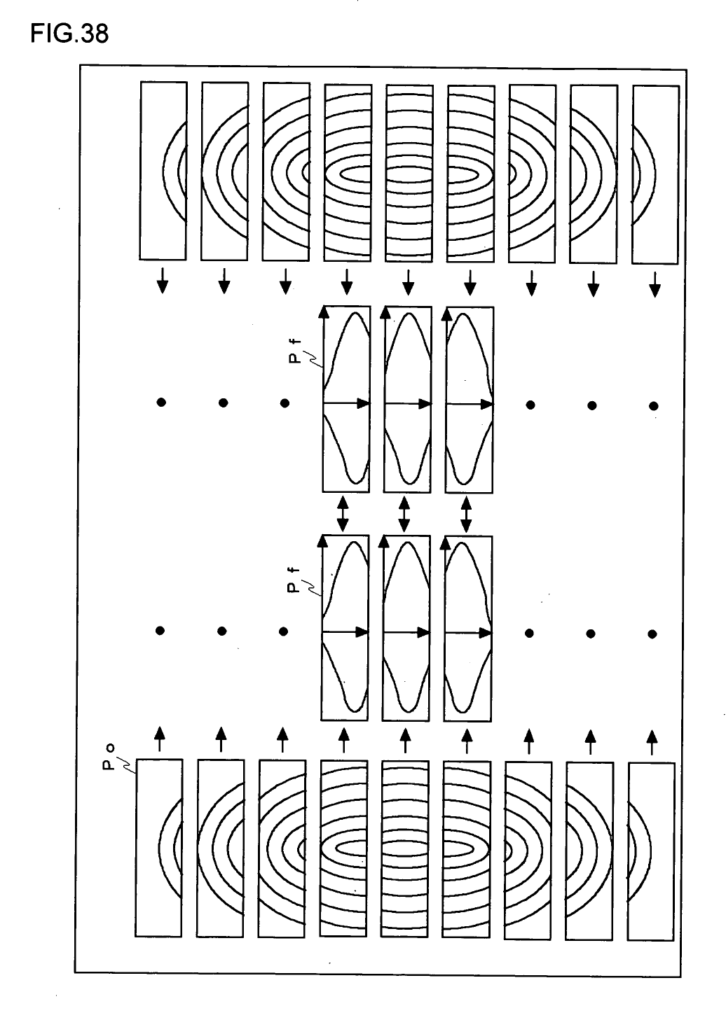

FIG. 38 illustrates an example where the characteristics are compared and verified for the respective partial images according to the twelfth embodiment. As have been described in the eleventh embodiment, the calculation 220 extracts the characteristics of the respective partial images. Then the characteristics of partial images are stored intact in the recording unit 240 as reference data, instead of reconstructing an entire image by joining the partial images. The characteristics of a set of partial images that constitute an entire image enrolled beforehand in the recording unit 240 are compared with and verified against the calculated characteristics of each partial image at the time of verification. In so doing, the characteristics of partial images corresponding to each other are compared and verified. It is to be noted that, among the partial images that constitute an entire image, there may be partial images not used for the verification. For example, the characteristics of partial images whose level of contribution to the verification is small may not be subjected to comparison and verification.

The verification apparatus 230 calculates the matching energy E, described in the first embodiment, for the respective partial images. Then the sum or average of the respective matching energies E is compared with a threshold value, prepared in advance, with which to determine the success of an authentication, so as to determine whether or not the user authentication is to be carried out.

According to the twelfth embodiment as described above, the comparison and verification are carried out for each partial image of an object to be captured instead of an arrangement in which the characteristics of an entire image is compared and verified. Thus, the entire image does not need to be constructed from the partial images, so that the images can be verified with a smaller memory capacity and a smaller calculation amount. For example, the structure according to the twelfth embodiment is suitable for such simple authentication as a case when the use of a game machine or toy is to be granted.

The present invention has been described based on the embodiments which are only exemplary. It is understood by those skilled in the art that there exist still other various modifications to the combination of each component and process described above and that such modifications are within the scope of the present invention.

In the above-described embodiments, the vector calculated from a gradient vector of each pixel is used, for each of linear regions, as a single physical quantity that characterizes the region. In this regard, the count of image gradation switching per linear region may be used as the single physical quantity. For example, an image is binarized so as to be a monochrome image, and the number of switches between black and white may be counted. The count value may be comprehended as the number of stripes of a fingerprint or the like. The density is high in a region where the stripes run vertical, so that the number of switches is large within a constant distance, namely, per unit length. This may be done in the x direction and the y direction. According to this modification, the verification can be carried out with simpler calculation and smaller memory capacity.

Though the binary data are used in the above embodiments, the multiple-tone data, such as 256-value data, may be used. In such a case, the method described in the above-mentioned literature “Tamura, Hideyuki, Ed., Computer Image Processing, pp. 182-191, Ohmsha, Ltd.” can be used, too, and the gradient vector of each pixel can be calculated. According to this modification, highly accurate verification can be achieved even though the calculation amount is increased compared with the case of monochrome images used.

When the above described verification processing is performed, any linear region that does not contain the stripe pattern may be skipped. For example, in such cases when the vector of more than a preset value cannot be detected for certain length of a line, when the white continues for more than a preset value, when the region is determined to be almost blacked out since the black continues for more than a preset value, when the count of switches between black and white is below a preset value, the processing is carried out excluding such a region depicted above. According to this modification, the amount of calculation in the verification processing can be reduced.

In the sixth to ninth embodiments, a thermal image indicative of thermal information on each pixel value may be picked up as an image, in addition to the normal images indicative of visible information, such as gradation, luminance and color information, and distance information on each pixel value. The thermal images can be picked up by use of an infrared thermography device, for example. In essence, it suffices if an image having gradation, luminance, color information, distance information, thermal information and other local image information is taken. If an thermal image is used, the effects of brightness of an image on a spot where images are picked up can be reduced. According to the sixth embodiment, the calculation unit 220 sets the data acquisition regions for the image data D1 and the image data D2, respectively. However, the data acquisition region set for the image data D1 may also be used as the data acquisition region of the image data D2. According to this modification, a step for setting a data acquisition region in the image data D2 can be omitted, so that the amount of calculation can be reduced.

The processing for constructing an entire image or the characteristics of the entire image using the characteristics of partial images according to the eleventh embodiment is applicable to a case at large where an entire image is constructed from partial images obtained after a simple segmentation.

While the preferred embodiments of the present invention have been described using specific terms, such description is for illustrative purposes only, and it is to be understood that changes and variations may be made without departing from the spirit or scope of the appended claims.

What is claimed is:

1. A verification method, comprising:
calculating, from a reference image for verification, a characteristic quantity that characterizes a direction of lines within the reference image along a first direction or calculating a characteristic quantity that characterizes the reference image as a single physical quantity;
setting a region from which data are to be acquired, by referring to the characteristic quantity;
calculating, from the region from which data are to be acquired, a characteristic quantity that characterizes a direction of lines within the reference image along a second direction different from the first direction or a characteristic quantity that characterizes the reference image as a single physical quantity; and
recording the characteristic quantity along the second direction.

2. A verification method according to claim 1, further comprising:
calculating, from an object image for verification, a characteristic quantity that characterizes a direction of lines within the object image along the first direction or a characteristic quantity that characterizes the object image as a single physical quantity;
setting a region from which data are to be acquired, by referring to the characteristic quantity;
calculating, from the region from which data to be acquired, a characteristic quantity that characterizes a direction of lines within the object image along the second direction or a characteristic quantity that characterizes the object image as a single physical quantity; and
verifying at least the characteristic quantity of the object image along the second direction against that of the reference image along the second direction.

3. A verification method, comprising:
dividing a reference image for verification, into a plurality of regions along a first direction;
calculating, for each of the plurality of divided regions, a characteristic quantity that characterizes a direction of lines within each region or a characteristic quantity that characterizes each region as a single physical quantity and then generating a group of characteristic quantities along the first direction;
setting a region from which data are to be acquired, by referring to the group of characteristic quantities;
dividing the region from which data are to be acquired, into a plurality of regions along a second direction different from the first direction;
calculating, for each of the plurality of divided regions, a characteristic quantity that characterizes a direction of lines within the region or a characteristic quantity that characterizes the region as a single physical quantity, and generating a group of characteristic quantities along the second direction; and
recording the group of characteristic quantities along the second direction.

4. A verification method according to claim 3, further comprising:
dividing an object image for verification, into a plurality of regions along the first direction;
calculating, for each of the plurality of divided regions, a characteristic quantity that characterizes a direction of lines within each region or a characteristic quantity that characterizes the region as a single physical quantity and then generating a group of characteristic quantities along the first direction;
setting a region from which data are to be acquired, by referring to the group of characteristic quantities;
dividing the region from which data are to be acquired, into a plurality of regions along the second direction;
calculating, for each of the plurality of divided regions, a characteristic quantity that characterizes a direction of lines within the region or a characteristic quantity that characterizes the region as a single physical quantity, and generating a group of characteristic quantities along the second direction; and
verifying at least the group of characteristic quantities of the object image along the second direction against that of the reference image along the second direction.

5. A verification method according to claim 2, wherein the reference image and the object image are at least two picked-up images in which an object is possibly present,
the method further comprising recognizing a region where the object is located, based on a verification result obtained from said verifying.

6. A verification method according to claim 3, further comprising:
resetting a region from which data are to be acquired, by referring to the group of characteristic quantities along the second direction;
dividing the region, from which data are to be acquired, into a plurality of regions along the first direction;
calculating, for each of the plurality of divided regions, a characteristic quantity that characterizes a direction of lines within each region or a characteristic quantity that characterizes each region as a single physical quantity, and regenerating a group of characteristic quantities along the first direction.

7. A verification method, comprising:
dividing a reference image or object image for verification into a plurality of regions;
calculating, for each of the plurality of divided regions, a characteristic quantity that characterizes a direction of lines within each region or a characteristic quantity that characterizes each region as a single physical quantity and then generating a group of characteristic quantities along a predetermined direction;
setting a region from which data are to be acquired, by referring to a characteristic quantity to be marked out among the group of characteristic quantities;
dividing the region from which data are to be acquired, into a plurality of regions along the predetermined direction; and
calculating, for each of the plurality of divided regions, a characteristic quantity that characterizes a direction of lines within each region or a characteristic quantity that characterizes each region as a single physical quantity and then regenerating a group of characteristic quantities along the predetermined direction.

8. A verification method, comprising:
dividing a reference image or object image for verification into a plurality of regions; and
calculating, for each of the plurality of divided regions, a characteristic quantity that characterizes a direction of lines within each region or a characteristic quantity that characterizes each region as a single physical quantity and then generating a group of characteristic quantities along a predetermined direction,
wherein said generating determines a range used for verification, by referring to a characteristic quantity to be marked out among the group of characteristic quantities.

9. A verification apparatus, comprising:
an image pickup unit which takes an object image for verification;
a calculation unit which calculates, from a picked-up object image, a characteristic quantity that characterizes a direction of lines within the object image along a first direction or a characteristic quantity that characterizes the object image as a single physical quantity; and
a verification unit which verifies a characteristic quantity of the object image against a characteristic quantity of a reference image,
wherein said calculation unit sets a region from which data are to be acquired, by referring to the characteristic quantity of the object image and calculates, from the region from which data are to acquired, a characteristic quantity that characterizes a direction of lines within the object image along a second direction different from the first direction or a characteristic quantity that characterizes the object image as a single physical quantity, and
wherein said verification unit at least verifies the characteristic quantity of the object image along the second direction against that of the reference image along the second direction.

10. A verification apparatus, comprising:
an image pickup unit which takes an object image for verification;
a calculation unit which calculates, for each of a plurality of regions obtained as a result of dividing a picked-up object image along a first direction, a characteristic quantity that characterizes a direction of lines within each region or a characteristic quantity that characterizes the each region as a single physical quantity and then generating a group of characteristic quantities along the first direction; and
a verification unit which verifies a group of characteristic quantities of the object image against that of a reference image,
wherein said calculation unit sets a region from which data are to be acquired, by referring to a group of characteristic quantities along the first direction and calculates, for each of a plurality of regions obtained as a result of dividing said region from which data are to be acquired along a second direction different from the first direction, a characteristic quantity that characterizes a direction of lines within said region or a characteristic quantity that characterizes said region as a single physical quantity and generates a group of characteristic quantities along the second direction, and
wherein said verification unit at least verifies the group of characteristic quantities of the object image along the second direction against that of the reference image along the second direction.
